(19) United States
(12) Patent Application Publication
(10) Pub. No.: US 2016/0143317 A1
(43) Pub. Date: May 26, 2016

(54) LACTIC ACID BACTERIUM AS PET DIETARY SUPPLEMENT

(71) Applicant: NUTRITION PHYSIOLOGY COMPANY, LLC, Guymon, OK (US)

(72) Inventor: Steven P. Lerner, Snellville, GA (US)

(21) Appl. No.: 14/950,230

(22) Filed: Nov. 24, 2015

Related U.S. Application Data
(60) Provisional application No. 62/083,477, filed on Nov. 24, 2014.

(51) Int. Cl. A23K 1/00; A23K 1/18; A23K 1/165

(52) U.S. Cl. CPC A23K 1/009; A23K 1/1653; A23K 1/1846; A23Y 2220/07

(57) ABSTRACT

Compositions and methods are disclosed for enhancing weight gain and feed efficiency in pets, such as dogs. The methods include administering to the pet a lactic acid producing bacterium (LAB) or combination of LABs as dietary supplements. The disclosed methods and compositions may also help reduce pathogen infection in dogs.

### RELATED APPLICATION

This application claims priority to U.S. Application No. 62/083,477, filed Nov. 24, 2014, which is hereby incorporated by reference in its entirety.

### BACKGROUND

I. Field of the Invention

The present disclosure pertains to the use of one or more lactic acid producing bacteria (also referred to as “lactic acid bacteria” or “LAB” in this disclosure) to enhance the well being of an animal. More particularly, the disclosure relates to the use of lactic acid bacteria as a dietary supplement to improve feed efficiency and/or to reduce pathogen infection in domestic pets.

II. Description of Related Art

Lactic acid bacteria have been used as direct-fed microbials (DFM) or probiotics for animals and humans. U.S. Pat. No. 5,534,271 disclosed use of certain lactic acid producing bacteria to improve feed efficiency in ruminants. U.S. Pat. No. 7,063,836 disclosed a unique combination of live lactic acid producing bacterium and live lactate utilizing bacterium as feed supplements to help reduce pre-harvest infections in ruminants. The compositions disclosed in U.S. Pat. No. 7,063,836 help reduce the numbers of enteropathogens, such as E. coli 0157:H7, among others.

It is not known whether the LAB strains that help improve feed efficiency and reduce pathogens in ruminants have the same effects in domestic pets (e.g., dogs or cats). The digestive and immune systems of ruminants are different from those of dogs. Ruminants and dogs also have very different native microflora. Therefore, a microorganism shown to be effective in ruminants may behave differently in dogs.

### SUMMARY

The present disclosure advances the art by providing methods and compositions for enhancing feed efficiency and for reducing pathogenic infection in a pet, such as a dog. In one aspect, the disclosed compositions and methods may be administered to a domesticated pet. Examples of domesticated pets may include but are not limited to a dog, a cat, among others. In one embodiment, it is disclosed here that supplementing lactic acid producing bacteria (LAB) to a dog may enhance feed efficiency. In another embodiment, the lactic acid bacteria may help reduce infection of the dog by various pathogens.

In one aspect, the LAB may be fed to the pet at a dosage effective in reducing the amount of at least one pathogen in the pet by at least 10%, 20%, 30%, 40%, 50%, 80%, 90%, 95% or more, as compared to the amount of the same pathogen in an untreated pet. For purpose of this disclosure, the term “at least one pathogen” may include but are not limited to one or more of Clostridium perfringens, Salmonella typhimurium, E. coli, Staphylococcus aureus, Bordetella bronchiseptica, Campylobacter jejuni. In one embodiment, the LAB may be fed to the pet at a dosage effective in reducing the amount of Clostridium perfringens in the pet by at least 10%, 20%, 30%, 40%, 50%, 80%, 90%, 95% or 100%, as compared to the amount of the same pathogen in an untreated pet. In another embodiment, the LAB may be fed to the pet at a dosage effective in reducing the amount of Clostridium perfringens in the pet by at least 10%, 20%, 30%, 40%, 50%, 80%, 90%, 95% or 100%, as compared to the amount of the same pathogen in the same pet prior to treatment. In another embodiment, the LAB may be fed to a dog at a daily dosage of about 1×10⁹ CFU per day, wherein said dosage is effective in reducing the amount of Clostridium perfringens in the dog by at least 10%, 20%, 30%, 40%, 50%, 80%, 90%, 95% or 100% after about 2 weeks, 3 weeks, 4 weeks, 5 weeks or 6 weeks as compared to the amount of the Clostridium perfringens in the same dog prior to treatment.

In one embodiment, the disclosed composition may contain one or more lactic acid producing bacteria (LAB). Examples of the LAB may include but are not limited to the genus of Lactobacillus. In one aspect, at least one of the lactic acid producing bacteria may be Lactobacillus acidophillus. Examples of Lactobacillus strains may include but are not limited to LA51, M35, LA45, NP28 (also known as C28) and L411 strains. In one aspect, two or more of these strains may be included in the disclosed composition. In another aspect, more than one lactic acid producing bacteria that belong to the same or different species may be used in the supplement. In another aspect, the composition does not contain significant amount of lactic acid utilizing bacteria. As used here, “significant” means the intake of a bacterium via supplementation is at least 100 CFU per day. In another aspect, the composition does not contain lactic acid utilizing bacteria. Examples of lactic acid utilizing bacteria include but are not limited to Propionibacterium freudenreichii, among others.

In one embodiment, a method is disclosed for improving feed utilization in a pet wherein a composition comprising a lactic acid bacterium is administered to the pet in a feed efficiency enhancing effective amount. In one aspect, the feed efficiency enhancing effective amount is a dosage from about 1×10² to about 1×10¹² CFU, from about 1×10⁶ to about 1×10¹⁰ CFU, from about 1×10⁸ to about 1×10¹⁰ CFU, or from about 1×10⁹ to about 5×10⁹ CFU of the lactic acid bacterium per day for each pet. In another embodiment, a method is disclosed for reducing pathogenic infection in a pet wherein a composition comprising a lactic acid bacterium is administered to the pet in a pathogen reducing effective amount. In another aspect, the pathogen reducing effective amount is a dosage from about 1×10² to about 1×10¹² CFU, from about 1×10⁶ to about 1×10¹⁰ CFU, from about 1×10⁸ to about 1×10¹⁰ CFU, or from about 1×10⁹ to about 5×10⁹ CFU of the lactic acid bacterium per day for each pet.

In one embodiment, the lactic acid producing bacteria may be administered to the pet separately from regular feed and/or drinks In another embodiment, the bacteria may be administered to the pet along with regular feed and/or drinks. In one aspect, the lactic acid producing bacteria may be pre-mixed with feed or water and may be administered to the pet in the form of a pre-mix. In another aspect, the LAB may be coated on pet (dog) chews or kibbles. In another aspect, the LAB may be pre-mixed with a feed specific for the domesticated pet, for example, feed specific for a particular breed of dogs, before being administered to the pet.

In one embodiment, the LAB may be mixed with maltodextrin and flavorings. In another embodiment, the LAB may be administered without mixing with maltodextrin. In another embodiment, the LAB may be administered without addition of flavorings. In another embodiment, the composition (e.g., NPC-210) to be administered to pets may contain more than 80% (w/w) maltodextrin (e.g., Maltrin 100). The composition may also contain from about 1-10% (w/w) of yeast extract (e.g., about 6% by weight), from about 0.1-10% (w/w) of chicken digest (e.g., about 0.8% by weight), from about 1-10% (w/w) of FOS (fructo-oligosaccharides) (e.g., about 6% by weight), from about 0.5-10% (w/w) of Silicon dioxide (e.g., about 1.3% by weight) and from about 0.1-10% (w/w) of Vanilla (e.g., about 0.8% by weight).

Dosage of the lactic acid bacteria supplement may vary depending on the species and size of the pets. The dosage may be determined based on factors such as body weight of the pet, stage of growth, season, or environmental factors, among others. In one embodiment, one or more strains of lactic acid bacteria may be administered to the pet at a dosage of between 1×10³ and 1×10¹⁰ CFU for each strain per pet per day. In another aspect, the dosage is between 1×10³ and 1×10⁸ CFU for each strain per pet per day. In another aspect, the dosage is between 1×10⁴ and 1×10⁶ CFU for each strain per pet per day. In another aspect, the dosage is between 1×10⁶ and 1×10⁹ CFU for each strain per pet per day. In another aspect, the dosage is between 1×10⁷ and 1×10⁸ CFU for each strain per pet per day. In another aspect, the dosage is about 1×10⁶ CFU for each strain per pet per day. In another aspect, the dosage is about 1×10⁸ CFU for each strain per pet per day. In another aspect, the dosage is from about 1×10⁹ to about 5×10⁹ CFU for each strain per pet per day.

The methods may further include a step wherein a pet is assessed to determine whether it is in need of LAB supplementation. The methods may also include a step wherein a pet is assessed to determine the effects of the LAB supplementation on feed efficiency or pathogen reduction. For instance, before the composition is administered to a pet, the feed efficiency of the pet may be measured or predicted in order to determine if the pet is in need of lactic acid bacteria supplements. The term “feed efficiency” (also referred to as “feed conversion” or “feed utilization”) is defined as the amount of feed by pound consumed for each pet in order for that pet to gain one pound of weight. In some instances, kilogram may be used in place of pound as the measurement unit for weight. Feed efficiency may be calculated by dividing the feed intake by the weight gain during the same period. Alternatively, the inverse calculation may be used to calculate feed efficiency. Feed efficiency may fluctuate slightly depending on the different energy levels of different diets.

After a period of supplements, the feed efficiency of the pet may be measured to determine the effects of the lactic acid bacteria supplements on feed efficiency. In one aspect, the lactic acid producing bacteria may help improve the feed efficiency of a dog by at least 0.1%, 0.2%, 0.5%, 1%, 2%, 3%, or 4%. In another aspect, the LAB supplement may increase weight gain of a dog by at least 0.1%, 0.2%, 0.5%, 1%, 2%, 3%, 4%, 5%, 6%, or 10% when compared to dogs that have not received the disclosed LAB supplement. In another aspect, the feed efficiency may be predicted based on empirical data obtained on same or similar breed of pets on the same or similar feed and grown under same or similar conditions.

In one aspect, the disclosed method may include a step of (a) administering to a pet a supplement containing a lactic acid producing bacterium at a dosage of from 1×10³ to 1×10¹⁰ CFU of the LAB per pet per day. In another aspect, the method may further include a step (b) of measuring the feed efficiency of the pet to determine if it is in need of the LAB supplement. Typically, step (b) is performed before said step (a). If it is determined that the pet is in need of the LAB supplement, step (a) is then performed.

The duration of the LAB supplementation varies. In one aspect, a pet's diet may be supplemented with the LAB continuously for 1-100 days daily at a dosage of 1×10⁶ to 1×10¹⁰ CFU of LAB per pet per day in order to achieve the desired effects. In another aspect, the a pet's diet may be supplemented with the LAB daily at a lower dose, for example, at 1×10³ to 1×10⁷ CFU of LAB per pet per day. In another aspect, the a pet's diet may be supplemented with the LAB once, twice, or three times a week for life. In another aspect, the a pet's diet may be supplemented with the LAB once, twice, or three times a month for life.

In another embodiment, the method may further include a step (c) to assess the effect of supplementation after at least 2 weeks of LAB supplementation performed in step (a). In one aspect, the feed efficiency obtained in step (c) is at least 2%, 3%, or 4% better than that obtained in step (b) described above. In another aspect, the pathogen count obtained in step (c) is at least 2%, 3%, or 4% lower than that obtained in step (b) described above.

### BRIEF DESCRIPTION OF THE DRAWINGS

FIG. 1 shows the fecal counts of lactic acid bacteria and Clostridium perfringens over time (cfu/g).

FIG. 2 shows the effect of NPC-210 on weight gain.

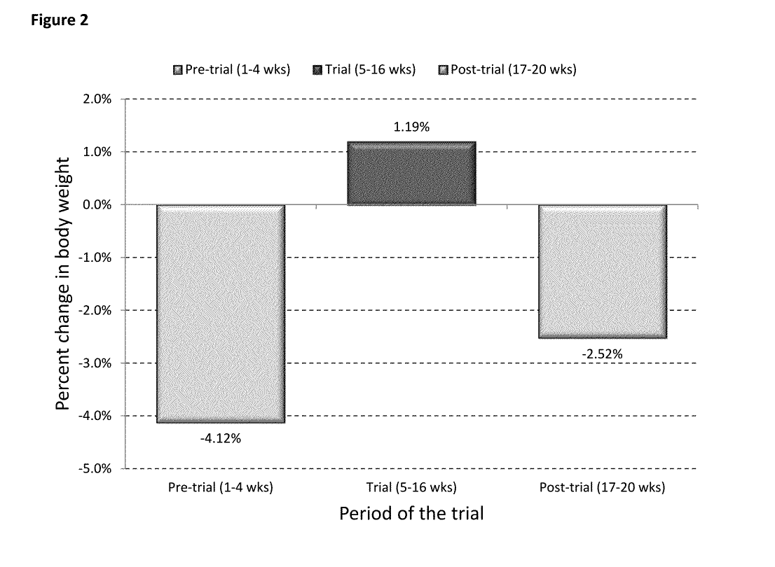

FIG. 3 shows the effect of NPC-210 on concentration of Clostridium perfringens in feces.

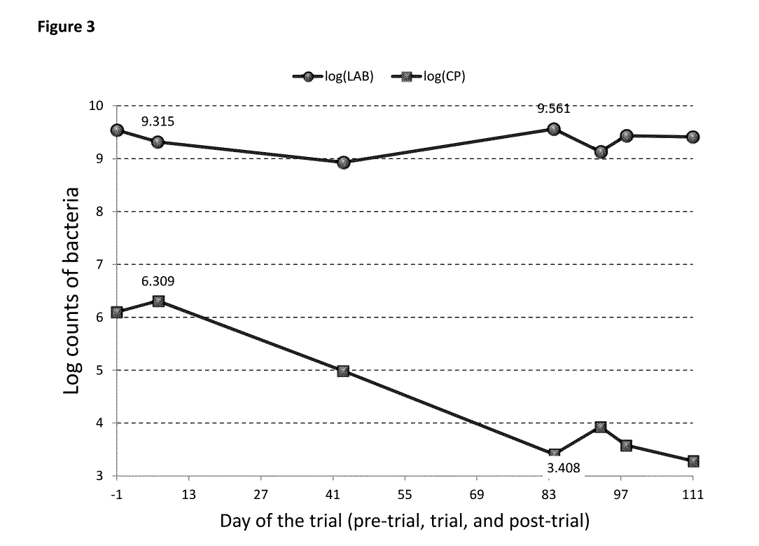

### DETAILED DESCRIPTION

This disclosure provides improved methods and compositions for enhancing the feed efficiency in pets. The disclosed methods and compositions may also help reduce pathogen infection in pets. The term “pet” refers to a dometicated animal. Examples of pets may include but are not limited to dogs, cats, rodents (e.g., hamsters, chinchillas, rats, mice, guinea pigs), rabbits, ferrets, among others.

As used herein, the term “pathogen” refers to a microorganism that may be harmful to a host animal, as well as a microorganism that may not be harmful to the host animal but may be harmful to a human who gets in contact with the host animal or waste from the host animal. By way of example, the most common pathogens for domestic pets include but are not limited to Salmonella spp. (e.g., Salmonella typhimurium), Clostridium perfringens, E. coli, Staphylococcus aureus, Bordetella bronchiseptica, Campylobacter jejuni.

Various commercially available products are described or used in this disclosure. It is to be recognized that these products or associated trade names are cited for purpose of illustration only. Certain physical or chemical properties and composition of the products may be modified without departing from the spirit of the present disclosure. One of ordinary skill in the art may appreciate that under certain circumstances, it may be more desirable or more convenient to alter the physical and/or chemical characteristics or composition of one or more of these products in order to achieve the same or similar objectives as taught by this disclosure. It is to be recognized that certain products or organisms may be marketed under different trade names which may in fact be identical to the products or organisms described herein.

It is to be noted that, as used in this specification and the claims, the singular forms “a,” “an,” and “the” include plural referents unless the context clearly dictates otherwise. Thus, for example, reference to “a pathogen” includes reference to one pathogen or a mixture of two or more pathogens, reference to “a lactic acid producing bacterium” includes reference to one or more lactic acid producing bacteria.

The terms “between,” “at least,” “from” and “to” as used herein are inclusive. For example, a range of “between 5 and 10” means any amount equal to or greater than 5 but equal to or smaller than 10.

For purpose of this disclosure, the term “precede” means one event or step is started before a second event or step is started.

The dosage of the bacterial supplements is defined by “CFU per day,” which refers to the number of colony forming units of the particular bacterial strain that is administered on the days when the bacterial strain is administered.

The terms “untreated” and “unsupplemented” are used interchangeably, and refer to animals (e.g., pets) that are fed identical or similar diet as the treated animals except for the omission of lactic acid producing bacteria from the diet. The term “performance” refers to one or more of the growth parameters, such as weight gain, feed conversion, and feed efficiency.

Administration of the bacterial supplement may be through oral ingestion with or without feed or water or may be mixed with feed and/or water. The bacterial supplement may be prepared as a pre-mix with feed and/or water or it may be mixed with feed or water on site at the time of administration to the pets. In one aspect, the bacterial supplements may be administered along with normal feed or water. In another aspect, the bacteria may be prepared in the form of a lyophilized culture before being mixed with water for spraying or blending with the feed and/or water. The final mixture may be in dry or wet form, and may contain additional carriers that are added to the normal feed of the pets. The normal feed may include one or more ingredients such as cereal grains, cereal grain by-products, or other commercial pet food products. The lyophilized cultures may also be added to the drinking water of the pets.

In another embodiment, the pet food ingredient and the lactic acid producing bacterium may form a pre-mix having certain geometric shape.By way of example, the pre-mix may have the shape of a pet chew, for example, a dog chew. In another aspect, the pre-mix may have the shape of a kibble, a bone, or a pet toy. In another embodiment, the lactic acid producing bacterium may adhere to the outside of the pre-mix. In another embodiment, the lactic acid producing bacterium may form a coating on the outside of the pre-mix.

The term “pet food ingredient” may refer to an ingredient commonly included in pet food. Examples of pet food ingredient may included but are not limited to cereal grain, by-products of cereal grain, food additives, maltodextrin, or flavorings. In one embodiment, one or more food ingredients may be included in the disclosed composition. In another embodiment, the composition may comprise one ore flavorings that may enhance the likability of the disclosed composition to a pet.

Preparation of the bacterial supplement to be mixed with feed or water may be performed as described in U.S. Pat. No. 7,063,836. Detection and enumeration of pathogenic bacteria may be conducted as described in Stephens et al. (2007). The contents of these references are hereby expressly incorporated by reference into this disclosure.

In one embodiment, the lactic acid producing bacterium may include one or more of the following: Bacillus subtilis, Bifidobacterium adolescentis, Bifidobacterium animalis, Bifidobacterium bifidum, Bifidobacterium infantis, Bifidobacterium longum, Bifidobacterium thermophilum, Lactobacillus acidophilus, Lactobacillus agilis, Lactobacillus alactosus, Lactobacillus alimentarius, Lactobacillus amylophilus, Lactobacillus amylovorans, Lactobacillus amylovorus, Lactobacillus animalis, Lactobacillus batatas, Lactobacillus bavaricus, Lactobacillus bifermentans, Lactobacillus bifidus, Lactobacillus brevis, Lactobacillus buchnerii, Lactobacillus bulgaricus, Lactobacillus catenaforme, Lactobacillus casei, Lactobacillus cellobiosus, Lactobacillus collinoides, Lactobacillus confusus, Lactobacillus coprophilus, Lactobacillus coryniformis, Lactobacillus corynoides, Lactobacillus crispatus, Lactobacillus curvatus, Lactobacillus delbrueckii, Lactobacillus desidiosus, Lactobacillus divergens, Lactobacillus enterii, Lactobacillus farciminis, Lactobacillus fermentum, Lactobacillus frigidus, Lactobacillus fructivorans, Lactobacillus fructosus, Lactobacillus gasseri, Lactobacillus halotolerans, Lactobacillus helveticus, Lactobacillus heterohiochii, Lactobacillus hilgardii, Lactobacillus hordniae, Lactobacillus inulinus, Lactobacillus jensenii, Lactobacillus jugurti, Lactobacillus kandleri, Lactobacillus kefir, Lactobacillus lactis, Lactobacillus leichmannii, Lactobacillus lindneri, Lactobacillus malefermentans, Lactobacillus mali, Lactobacillus maltaromicus, Lactobacillus minor, Lactobacillus minutus, Lactobacillus mobilis, Lactobacillus murinus, Lactobacillus pentosus, Lactobacillus plantarum, Lactobacillus pseudoplantarum, Lactobacillus reuteri, Lactobacillus rhamnosus, Lactobacillus rogosae, Lactobacillus tolerans, Lactobacillus torquens, Lactobacillus ruminis, Lactobacillus sake, Lactobacillus salivarius, Lactobacillus sanfrancisco, Lactobacillus sharpeae, Lactobacillus trichodes, Lactobacillus vaccinostercus, Lactobacillus viridescens, Lactobacillus vitulinus, Lactobacillus xylosus, Lactobacillus yamanashiensis, Lactobacillus zeae, Pediococcus acidilactici, Pediococcus pentosaceus, Streptococcus cremoris, Streptococcus diacetylactis, Streptococcus (Enterococcus) faecium, Streptococcus intermedius, Streptococcus lactis, Streptococcus thermophilus, and combinations thereof.

In one embodiment, the disclosed composition does not contain significant amount of lactic acid utilizing bacterium. Examples of lactate utilizing bacterium may include Megasphaera elsdenii, Peptostreptococcus asaccharolyticus, Propionibacterium freudenreichii, Propionibacterium acidipropionici, Propionibacterium globosum, Propionibacterium jensenii, Propionibacterium shermanii, Propionibacterium spp., Selenomonas ruminantium, and combinations thereof. In another embodiment, the disclosed composition does not contain significant amount of Propionibacterium freudenreichii.

In one embodiment, the lactic acid producing bacterium is Lactobacillus acidophilus or Lactobacillus animalis. Examples of the lactic acid producing bacterium strains may include but are not limited to the LA51, M35, LA45, NP28, and L411. In another embodiment, the lactic acid producing bacterium strain is LA51. The term Lactobacillus acidophilus/animalis may be used to indicate that either Lactobacillus acidophilus or Lactobacillus animalis may be used. It is worth noting that when strain LA51 was first isolated, it was identified as a Lactobacillus acidophilus by using an identification method based on positive or negative reactions to an array of growth substrates and other compounds (e.g., API 50-CHL or Biolog test). Using modern genetic methods, however, strain LA51 has been confirmed as belonging to the species Lactobacillus animalis (unpublished results). Regardless of the possible taxonomic changes for LA51, the strain LA51 remains the same as the one that has been deposited with ATCC. In another embodiment, the lactic acid producing bacterium is a Lactobacillus animalis that is not native to canines, i.e., not a Lactobacillus animalis strain that naturally grows in the digestive system of canines or can be isolated from feces of canines Lactic acid producing bacteria that are not native to dogs may be advatangeous as compared to those that are isolated or derived from dogs or dogs' feces. For instance, these non-native LAB may be more robust in the digestive system of dogs, and may be more effective in inhibiting pathogens in the digestive system of dogs.

Lactobacillus strains C28, M35, LA45 and LA51 strains were deposited with the American Type Culture Collection (ATCC) on May 25, 2005 and have the Deposit numbers of PTA-6748, PTA-6751, PTA-6749 and PTA-6750, respectively. Lactobacillus strain L411 was deposited with the American Type Culture Collection (ATCC) on Jun. 30, 2005 and has the Deposit number PTA-6820. These deposits were made in compliance with the Budapest Treaty requirements that the duration of the deposit should be for thirty (30) years from the date of deposit or for five (5) years after the last request for the deposit at the depository, or for the enforceable life of a patent that results from this application, whichever is longer. The strains will be replenished should it become non-viable at the Depository.

The following examples are provided to illustrate the present disclosure, but are not intended to be limiting. The feed ingredients and supplements are presented as typical components, and various substitutions or modifications may be made in view of this disclosure by one of skills in the art without departing from the principle and spirit of the present invention.

Certain feeding tests described in the Examples contain ingredients that are in a size suitable for a small scale setting. It is important to note that these small scale tests may be scaled up and the principle of operation and the proportion of each ingredient in the system may equally apply to a larger scale feeding system. Unless otherwise specified, the percentages of ingredients used in this disclosure are on a w/w basis.

### EXAMPLES

### Example 1

### LAB Supplement Improves Feed Efficiency

Tests were performed to evaluate the efficacy and safety of a probiotic supplement for digestive health when offered to adult dogs.

The protocol for this study was reviewed and approved prior to study initiation by Institutional Animal Care and Use Committee of the Test Facility and was in compliance with the Animal Welfare Act.

Healthy adult dogs were used for these studies. Dogs were individually housed during the study. 12-hour-light/12-hour-dark cycle. Every attempt was made to keep temperature ranges within targeted conditions (from 50 to 85 F) in accordance with the Animal Welfare Act. Cages and feeders were cleaned daily and sanitized in accordance with the Animal Welfare Act. Fresh tap water, fit for human consumption, was available ad libitum by means of an automatic watering system. There were no known contaminants that were reasonably expected to be present in the dietary material that were known to be capable of interfering with the purpose or conduct of the study.

Individual body weights were measured and recorded at the beginning, weekly, and at the conclusion of the test. Standard colony diet was meal-fed, checked daily, and supplied in appropriate amounts according to body weight prior to study initiation. Standard colony diet, Joy Special Meal, was meal-fed, checked daily, and supplied in appropriate amounts according to body weight throughout the course of the study. Dogs were fed according to body condition score in order to maintain body weight. The standard diet was offered for one hour per day for 28 days (Day-28 to Day 0). On Days 1-84, a test amount of the test article, NPC-210, was mixed with a smaller portion (75 grams) of Joy Special Meal to ensure the dogs consumed the entire ration of the test article. The test amount of NPC-210 contained about 1.1×10⁹ CFU LA51 in a dry powder form. In addition to LA51, NPC-210 also contained maltodextrin and flavorings. The remaining portion of Joy Special Meal was offered for one hour after the earlier ration was removed. On Days 85-112 the dogs were no longer offered the supplement and fed the standard diet only. Feeding quantities were adjusted to maintain body weight.

The test ran for 20 weeks. The study began on Day-28. Twenty dogs were placed on the standard diet on Day-28. On Days-22 to -21,-15 to -14 and -1 to 0, feces were collected from the dogs for fecal culture. Prior to study initiation (Day-28) and on Day 1, blood was collected for hematology and clinical chemistry. Starting on Day 1 the supplement was fed to the dogs. On Days 7-8, 43-44, and 84-85 feces were collected for fecal culture. On Day 85 blood was once again collected for hematology and clinical chemistry. On Day 85 the dogs no longer received the supplement and were fed the standard diet only. Feces were collected on Days 93-94, 98-99 and 111-112 for fecal culture. Blood was collected on Day 113 for hematology and clinical chemistry. Dogs were evaluated daily for any adverse reactions or clinical signs. Fecal consistency evaluations were performed on Days-25,-21,-18,-14,-10,-7,-4, 0, 3, 7, 10, 14, 17, 21, 25, 28, 32, 35, 39, 42, 46, 49, 53, 56, 60, 63, 67, 70, 74, 77, 81, 84, 88, 91, 95, 98, 102, 105, 109, 112. Acceptance of the test article was determined by measuring daily food consumption. Diagnostic values and observations were compared for each dog using hematology and clinical chemistry results, fecal culture results, stool quality evaluations, food consumption, changes in body weights, clinical observations and physical examination findings from pre- treatment values to post-treatment values to determine if there were any clinical changes that may have been due to the intake of the test article.

Body Weight: The mean percent (%) change in body weights increased when the dogs received the test article along with Joy Special Meal. When the dogs were on Joy Special meal alone for the four weeks at the beginning and end of the study the mean (%) body weight change was decreased. Body weights are presented in Table 1.

TABLE 1
Weekly Body Weights (kg)
Joy Special Meal Only

| | | Week | | | | | |
|---|---|---|---|---|---|---|---|
| Dog ID | Sex | 1 | 2 | 3 | 4 | Chg. | % Chg. |
| 13444 | M | 10.61 | 10.16 | 10.26 | 10.47 | −0.14 | −1.32 |
| 1490193 | M | 12.13 | 11.64 | 11.42 | 11.44 | −0.69 | −5.69 |
| 13454 | F | 8.93 | 8.39 | 8.25 | 8.24 | −0.69 | −7.73 |
| 13298 | M | 11.94 | 11.90 | 12.12 | 12.29 | 0.35 | 2.93 |
| 13304 | M | 12.36 | 12.26 | 12.35 | 12.49 | 0.13 | 1.05 |
| 12980 | M | 14.61 | 14.41 | 14.54 | 14.79 | 0.18 | 1.23 |
| 12749 | F | 11.15 | 10.84 | 10.63 | 10.46 | −0.69 | −6.19 |
| 12969 | F | 12.17 | 11.63 | 11.41 | 11.15 | −1.02 | −8.38 |
| 13019 | M | 11.89 | 11.27 | 11.07 | 11.13 | −0.76 | −6.39 |
| 12933 | F | 13.46 | 12.70 | 12.78 | 12.85 | −0.61 | −4.53 |
| 13010 | M | 10.84 | 10.65 | 10.76 | 10.96 | 0.12 | 1.11 |
| 12640 | F | 11.78 | 11.13 | 11.18 | 11.03 | −0.75 | −6.37 |
| 12798 | M | 11.67 | 11.09 | 11.14 | 10.89 | −0.78 | −6.68 |
| 13248 | F | 10.93 | 10.74 | 10.75 | 10.65 | −0.28 | −2.56 |
| 13178 | F | 8.86 | 8.52 | 8.38 | 8.27 | −0.59 | −6.66 |
| 13014 | F | 10.29 | 9.90 | 10.07 | 10.06 | −0.23 | −2.24 |
| 12672 | F | 11.53 | 10.90 | 10.91 | 10.83 | −0.70 | −6.07 |
| 13319 | F | 6.28 | 5.89 | 5.84 | 5.82 | −0.46 | −7.32 |
| 13381 | F | 9.21 | 8.72 | 8.60 | 8.63 | −0.58 | −6.30 |
| 13223 | F | 12.83 | 12.36 | 11.80 | 12.28 | −0.55 | −4.29 |
| | Mean: | 11.17 | 10.76 | 10.71 | 10.74 | −0.44 | −4.12 |
| | SD: | 1.841 | 1.848 | 1.873 | 1.937 | 0.384 | 3.452 |

Joy Special Meal plus NPC-210

| | | Week | | | | | | | |
|---|---|---|---|---|---|---|---|---|---|
| Dog ID | Sex | 5 | 6 | 7 | 8 | 9 | 10 | | |
| 13444 | M | 10.27 | 10.37 | 10.02 | 10.20 | 10.30 | 10.37 | | |
| 1490193 | M | 11.24 | 11.64 | 11.41 | 11.25 | 11.55 | 11.56 | | |
| 13454 | F | 8.18 | 8.59 | 8.68 | 8.73 | 8.91 | 8.93 | | |
| 13298 | M | 12.37 | 12.67 | 12.26 | 11.99 | 11.67 | 11.65 | | |
| 13304 | M | 12.56 | 12.70 | 12.14 | 11.90 | 11.85 | 11.64 | | |
| 12980 | M | 14.84 | 14.99 | 14.79 | 14.57 | 14.59 | 14.55 | | |
| 12749 | F | 10.12 | 10.19 | 10.13 | 9.97 | 9.99 | 9.67 | | |
| 12969 | F | 10.98 | 11.40 | 11.38 | 11.41 | 11.46 | 11.20 | | |
| 13019 | M | 11.07 | 11.41 | 11.27 | 11.43 | 11.38 | 11.59 | | |
| 12933 | F | 12.74 | 12.65 | 12.74 | 12.66 | 12.93 | 12.80 | | |
| 13010 | M | 11.12 | 11.08 | 10.86 | 10.65 | 10.54 | 10.60 | | |
| 12640 | F | 10.98 | 10.97 | 10.92 | 10.93 | 11.03 | 11.02 | | |
| 12798 | M | 10.98 | 11.38 | 11.35 | 11.38 | 11.21 | 10.68 | | |
| 13248 | F | 10.53 | 10.78 | 10.77 | 10.82 | 10.90 | 10.87 | | |
| 13178 | F | 8.12 | 8.25 | 8.16 | 8.15 | 8.22 | 8.29 | | |
| 13014 | F | 9.92 | 10.50 | 10.27 | 10.23 | 10.17 | 10.14 | | |
| 12672 | F | 10.66 | 11.07 | 11.21 | 11.41 | 11.54 | 11.41 | | |
| 13319 | F | 5.80 | 5.75 | 5.64 | 5.82 | 5.58 | 5.62 | | |
| 13381 | F | 8.56 | 8.86 | 8.87 | 8.99 | 8.94 | 9.03 | | |
| 13223 | F | 12.23 | 12.10 | 12.47 | 12.42 | 12.54 | 12.56 | | |
| | Mean: | 10.66 | 10.87 | 10.77 | 10.75 | 10.77 | 10.71 | | |
| | SD: | 1.966 | 1.959 | 1.932 | 1.854 | 1.894 | 1.863 | | |
| | | Week | | | | | | | |
| Dog ID | Sex | 11 | 12 | 13 | 14 | 15 | 16 | Chg. | % Chg. |
| 13444 | M | 10.19 | 10.33 | 10.50 | 10.53 | 10.52 | 10.49 | 0.22 | 2.14 |
| 1490193 | M | 11.77 | 11.53 | 11.70 | 11.67 | 11.54 | 11.39 | 0.15 | 1.33 |
| 13454 | F | 8.99 | 8.96 | 9.14 | 9.30 | 9.35 | 9.48 | 1.30 | 15.89 |
| 13298 | M | 11.36 | 11.53 | 11.54 | 11.92 | 12.01 | 12.29 | −0.08 | −0.65 |
| 13304 | M | 11.54 | 11.78 | 11.55 | 11.99 | 12.04 | 12.10 | −0.46 | −3.66 |
| 12980 | M | 14.15 | 14.17 | 14.17 | 14.32 | 13.94 | 14.17 | −0.67 | −4.51 |
| 12749 | F | 9.38 | 9.36 | 9.28 | 9.39 | 9.38 | 9.24 | −0.88 | −8.70 |
| 12969 | F | 11.11 | 10.94 | 11.03 | 11.07 | 10.95 | 10.96 | −0.02 | −0.18 |
| 13019 | M | 11.64 | 11.78 | 11.74 | 12.04 | 12.05 | 12.18 | 1.11 | 10.03 |
| 12933 | F | 12.80 | 12.84 | 13.04 | 13.16 | 13.05 | 13.29 | 0.55 | 4.32 |
| 13010 | M | 10.03 | 9.93 | 9.76 | 10.05 | 9.93 | 9.94 | −1.18 | −10.61 |
| 12640 | F | 10.74 | 10.80 | 10.97 | 11.01 | 10.92 | 10.90 | −0.08 | −0.73 |
| 12798 | M | 10.68 | 11.02 | 11.16 | 11.36 | 11.51 | 11.51 | 0.53 | 4.83 |
| 13248 | F | 10.87 | 10.32 | 10.00 | 10.01 | 10.06 | 9.90 | −0.63 | −5.98 |
| 13178 | F | 8.39 | 8.81 | 8.71 | 8.48 | 8.37 | 8.39 | 0.27 | 3.33 |
| 13014 | F | 10.26 | 10.47 | 10.48 | 10.45 | 10.38 | 10.11 | 0.19 | 1.92 |
| 12672 | F | 11.26 | 11.24 | 11.18 | 11.41 | 11.26 | 11.10 | 0.44 | 4.13 |
| 13319 | F | 5.61 | 5.53 | 5.42 | 5.69 | 5.98 | 5.95 | 0.15 | 2.59 |
| 13381 | F | 9.04 | 9.05 | 8.92 | 9.06 | 9.05 | 8.89 | 0.33 | 3.86 |
| 13223 | F | 12.69 | 12.37 | 12.27 | 12.53 | 12.33 | 12.78 | 0.55 | 4.50 |
| | Mean: | 10.63 | 10.64 | 10.63 | 10.77 | 10.73 | 10.75 | 0.09 | 1.19 |
| | SD: | 1.827 | 1.810 | 1.849 | 1.876 | 1.790 | 1.885 | 0.624 | 6.093 |

Joy Special Meal Only

| | | Week | | | | | |
|---|---|---|---|---|---|---|---|
| Dog ID | Sex | 17 | 18 | 19 | 20 | Chg. | % Chg. |
| 13444 | M | 10.47 | 10.28 | 10.44 | 10.41 | −0.06 | −0.57 |
| 1490193 | M | 11.58 | 11.09 | 11.31 | 11.28 | −0.30 | −2.59 |
| 13454 | F | 9.32 | 9.17 | 8.88 | 8.58 | −0.74 | −7.94 |
| 13298 | M | 12.34 | 12.29 | 12.32 | 12.32 | −0.02 | −0.16 |
| 13304 | M | 12.49 | 12.54 | 12.91 | 12.65 | 0.16 | 1.28 |
| 12980 | M | 14.22 | 14.44 | 14.53 | 14.71 | 0.49 | 3.45 |
| 12749 | F | 9.32 | 9.18 | 9.19 | 9.36 | 0.04 | 0.43 |
| 12969 | F | 11.14 | 10.81 | 10.72 | 10.49 | −0.65 | −5.83 |
| 13019 | M | 12.31 | 11.98 | 12.12 | 11.89 | −0.42 | −3.41 |
| 12933 | F | 13.27 | 13.24 | 13.44 | 13.44 | 0.17 | 1.28 |
| 13010 | M | 10.05 | 10.47 | 10.61 | 10.90 | 0.85 | 8.46 |
| 12640 | F | 11.16 | 11.33 | 11.21 | 11.23 | 0.07 | 0.63 |
| 12798 | M | 11.68 | 11.57 | 11.44 | 11.20 | −0.48 | −4.11 |
| 13248 | F | 10.23 | 10.06 | 9.22 | 9.46 | −0.77 | −7.53 |
| 13178 | F | 8.76 | 8.68 | 8.56 | 8.30 | −0.46 | −5.25 |
| 13014 | F | 10.29 | 9.95 | 9.62 | 9.28 | −1.01 | −9.82 |
| 12672 | F | 11.12 | 10.78 | 10.45 | 10.21 | −0.91 | −8.18 |
| 13319 | F | 6.00 | 5.88 | 5.92 | 5.85 | −0.15 | −2.50 |
| 13381 | F | 9.08 | 8.80 | 8.63 | 8.54 | −0.54 | −5.95 |
| 13223 | F | 12.42 | 12.38 | 12.29 | 12.15 | −0.27 | −2.17 |
| | Mean: | 10.86 | 10.75 | 10.69 | 10.61 | −0.25 | −2.52 |
| | SD: | 1.855 | 1.904 | 2.003 | 2.032 | 0.475 | 4.509 |

Food Consumption: The differences in mean weekly food consumption recorded when dogs were fed Joy Special Meal compared to the mean weekly food consumption when dogs fed Joy Special Meal plus NPC-210 were minimal. The entire ration of NPC-210 was consumed in its entirety for each dog on study. Food consumption is presented in Table 2.

TABLE 2
Average Daily Food Consumption per Week (g)
Joy Special Meal Only

| | | Week | | | | |
|---|---|---|---|---|---|---|
| Dog ID | Sex | 1 | 2 | 3 | 4 | Average |
| 13444 | M | 269 | 250 | 294 | 251 | 266 |
| 1490193 | M | 202 | 230 | 230 | 218 | 220 |
| 13454 | F | 111 | 148 | 192 | 144 | 149 |
| 13298 | M | 350 | 350 | 350 | 350 | 350 |
| 13304 | M | 300 | 300 | 300 | 300 | 300 |
| 12980 | M | 300 | 300 | 300 | 300 | 300 |
| 12749 | F | 250 | 250 | 250 | 250 | 250 |
| 12969 | F | 100 | 118 | 132 | 160 | 128 |
| 13019 | M | 170 | 203 | 229 | 221 | 206 |
| 12933 | F | 200 | 200 | 200 | 200 | 200 |
| 13010 | M | 300 | 300 | 300 | 300 | 300 |
| 12640 | F | 196 | 200 | 200 | 200 | 199 |
| 12798 | M | 192 | 219 | 239 | 267 | 229 |
| 13248 | F | 285 | 258 | 256 | 197 | 249 |
| 13178 | F | 168 | 166 | 163 | 156 | 163 |
| 13014 | F | 144 | 193 | 176 | 151 | 166 |
| 12672 | F | 142 | 146 | 155 | 141 | 146 |
| 13319 | F | 124 | 175 | 187 | 164 | 163 |
| 13381 | F | 222 | 243 | 258 | 249 | 243 |
| 13223 | F | 200 | 200 | 200 | 200 | 200 |
| | Mean: | 211 | 222 | 231 | 221 | 221 |
| | SD: | 71.5 | 59.9 | 57.9 | 60.8 | 60.9 |

Joy Special Meal plus NPC-210

| | | Week | | | | | | | | | | | | |
|---|---|---|---|---|---|---|---|---|---|---|---|---|---|---|
| Dog ID | Sex | 5 | 6 | 7 | 8 | 9 | 10 | 11 | 12 | 13 | 14 | 15 | 16 | Average |
| 13444 | M | 296 | 220 | 265 | 275 | 291 | 300 | 279 | 295 | 258 | 269 | 280 | 266 | 275 |
| 1490193 | M | 325 | 221 | 254 | 294 | 284 | 300 | 285 | 326 | 289 | 308 | 338 | 262 | 290 |
| 13454 | F | 286 | 227 | 213 | 215 | 208 | 225 | 196 | 225 | 221 | 202 | 175 | 157 | 213 |
| 13298 | M | 357 | 264 | 250 | 250 | 271 | 275 | 296 | 300 | 321 | 325 | 325 | 325 | 297 |
| 13304 | M | 307 | 214 | 200 | 221 | 246 | 271 | 296 | 300 | 312 | 325 | 325 | 325 | 279 |
| 12980 | M | 307 | 236 | 225 | 225 | 225 | 225 | 225 | 225 | 253 | 775 | 275 | 296 | 249 |
| 12749 | F | 257 | 207 | 210 | 240 | 258 | 279 | 296 | 321 | 338 | 361 | 386 | 471 | 302 |
| 12969 | F | 207 | 200 | 200 | 180 | 182 | 174 | 181 | 187 | 193 | 176 | 218 | 220 | 193 |
| 13019 | M | 307 | 236 | 243 | 250 | 271 | 275 | 275 | 275 | 275 | 275 | 275 | 275 | 269 |
| 12933 | F | 207 | 200 | 200 | 200 | 221 | 225 | 225 | 225 | 225 | 225 | 225 | 225 | 217 |
| 13010 | M | 307 | 236 | 225 | 225 | 246 | 207 | 221 | 246 | 271 | 275 | 275 | 318 | 254 |
| 12640 | F | 207 | 200 | 200 | 200 | 221 | 225 | 225 | 225 | 225 | 225 | 225 | 268 | 221 |
| 12798 | M | 332 | 256 | 239 | 224 | 208 | 279 | 275 | 296 | 300 | 300 | 294 | 291 | 274 |
| 13248 | F | 280 | 228 | 188 | 195 | 216 | 214 | 161 | 198 | 199 | 190 | 233 | 204 | 209 |
| 13178 | F | 196 | 219 | 192 | 195 | 192 | 275 | 269 | 166 | 149 | 186 | 229 | 267 | 211 |
| 13014 | F | 260 | 236 | 199 | 160 | 216 | 219 | 225 | 210 | 206 | 203 | 184 | 204 | 210 |
| 12672 | F | 207 | 200 | 200 | 200 | 200 | 200 | 221 | 225 | 225 | 214 | 215 | 195 | 209 |
| 13319 | F | 221 | 201 | 219 | 170 | 165 | 179 | 138 | 156 | 181 | 173 | 192 | 198 | 183 |
| 13381 | F | 340 | 201 | 252 | 255 | 257 | 270 | 241 | 264 | 266 | 254 | 248 | 255 | 264 |
| 13223 | F | 207 | 221 | 225 | 225 | 232 | 250 | 242 | 250 | 250 | 250 | 250 | 250 | 238 |
| | Mean: | 271 | 224 | 220 | 220 | 231 | 243 | 239 | 246 | 248 | 251 | 258 | 264 | 243 |
| | SD: | 53.2 | 20.3 | 23.5 | 34.2 | 34.4 | 38.7 | 45.9 | 50.1 | 50.0 | 54.8 | 55.3 | 67.6 | 36.9 |

Joy Special Meal Only

| | | Week | | | | |
|---|---|---|---|---|---|---|
| Dog ID | Sex | 17 | 18 | 19 | 20 | Average |
| 13444 | M | 255 | 250 | 263 | 264 | 258 |
| 1490193 | M | 312 | 326 | 425 | 389 | 363 |
| 13454 | F | 128 | 150 | 132 | 107 | 129 |
| 13298 | M | 325 | 325 | 325 | 325 | 325 |
| 13304 | M | 325 | 325 | 307 | 300 | 314 |
| 12980 | M | 300 | 300 | 300 | 300 | 300 |
| 12749 | F | 433 | 493 | 488 | 500 | 479 |
| 12969 | F | 128 | 159 | 146 | 150 | 146 |
| 13019 | M | 191 | 228 | 203 | 234 | 214 |
| 12933 | F | 225 | 225 | 225 | 225 | 225 |
| 13010 | M | 325 | 325 | 294 | 325 | 317 |
| 12640 | F | 275 | 257 | 238 | 250 | 255 |
| 12798 | M | 225 | 226 | 220 | 256 | 232 |
| 13248 | F | 170 | 169 | 132 | 156 | 157 |
| 13178 | F | 193 | 178 | 140 | 130 | 160 |
| 13014 | F | 125 | 109 | 125 | 112 | 118 |
| 12672 | F | 128 | 151 | 134 | 148 | 140 |
| 13319 | F | 143 | 157 | 154 | 162 | 154 |
| 13381 | F | 184 | 192 | 195 | 218 | 197 |
| 13223 | F | 247 | 293 | 248 | 309 | 274 |
| | Mean: | 232 | 242 | 235 | 243 | 238 |
| | SD: | 86.2 | 91.3 | 100.6 | 100.9 | 93.3 |

Stool Quality: No differences in stool quality were observed when the dogs were fed Joy Special Meal compared to the when dogs were fed Joy Special Meal plus the NPC-210. The average stool score was a 3 (moist, formed) when dogs were fed Joy Special Meal alone or Joy Special Meal plus NPC-210. Fecal consistency results are shown in Table 3.

TABLE 3
Fecal Consistency Observation Ratings
Joy Special Meal Only
Dog ID

| | 13444 | | 1490193 | | 13454 | | 13298 | | 13304 | | 12980 | | 12749 | | 12969 | | 13019 | | 12933 | |
|---|---|---|---|---|---|---|---|---|---|---|---|---|---|---|---|---|---|---|---|---|
| Day | AM | PM | AM | PM | AM | PM | AM | PM | AM | PM | AM | PM | AM | PM | AM | PM | AM | PM | AM | PM |
| Day | 3.5 | 0 | 3.5 | 0 | 3, | 0 | 3, | 0 | 3.5 | 0 | 3.5 | 0 | 3.5 | 0 | 3.5 | 0 | 3 | 0 | 3.5 | 0 |
| −25 | | | | | 3.5 | | 3.5 | | | | | | | | | | | | | |
| Day | 3.5 | 3 | 3.5 | 3.5 | 3.5 | 0 | 3.5 | 0 | 3, | 0 | 3.5 | 3 | 3.5 | 3.5 | 3.5 | 0 | 3, | 0 | 3.5 | 0 |
| −21 | | | | | | | | | 3.5 | | | | | | | | 3.5 | | | |
| Day | 3 | 0 | 3, | 2.5, | 3.5 | 0 | 3.5 | 0 | 3.5 | 0 | 3.5 | 3.5 | 3.5 | 3 | 3.5 | 3.5 | 3, | 0 | 3, | 0 |
| −18 | | | 3.5 | 3.5 | | | | | | | | | | | | | 3.5 | | 3.5 | |
| Day | 3, | 3 | 3 | 3 | 3.5 | 0 | 3.5 | 2.5 | 3.5 | 0 | 3.5 | 2.5 | 3.5 | 0 | 3.5 | 0 | 2.5, | 2.5 | 3 | 3 |
| −14 | 3.5 | | | | | | | | | | | | | | | | 3.5 | | | |
| Day | 2.5 | 2.5 | 3 | 3 | 3.5 | 0 | 3 | 0 | 2.3 | 0 | 3.5 | 0 | 2.5, | 0 | 3, | 0 | 3, | 0 | 2.5, | 0 |
| −10 | | | | | | | | | | | | | 3 | | 3.5 | | 3.5 | | 3 | |
| Day | 3 | 0 | 2.5, | 3 | 3 | 0 | 3.5 | 3 | 3.5 | 3 | 3 | 0 | 3, | 0 | 3 | 0 | 3, | 0 | 3 | 0 |
| −7 | | | 3 | | | | | | | | | | 3.5 | | | | 3.5 | | | |
| Day | 3.5 | 0 | 2.5 | 0 | 3.5 | 0 | 3.5 | 3.5 | 2 | 0 | 3.5 | 0 | 3.5 | 0 | 3 | 0 | 2.5, | 0 | 2 | 0 |
| −4 | | | | | | | | | | | | | | | | | 3 | | | |
| Day | 3 | 0 | 3 | 2.5 | 3 | 0 | 2.5 | 0 | 2.5, | 0 | 3.5 | 3 | 3.5 | 0 | 3 | 3 | 3.5 | 3, | 3 | 0 |
| −1 | | | | | | | | | 3 | | | | | | | | | 3.5 | | |

Dog ID

| | 13010 | | 12640 | | 12798 | | 13248 | | 13178 | | 13014 | | 12672 | | 13319 | | 13381 | | 13223 | |
|---|---|---|---|---|---|---|---|---|---|---|---|---|---|---|---|---|---|---|---|---|
| Day | AM | PM | AM | PM | AM | PM | AM | PM | AM | PM | AM | PM | AM | PM | AM | PM | AM | PM | AM | PM |
| Day | 3.5 | 0 | 3.5 | 0 | 3, | 0 | 3, | 3 | 3 | 0 | 3 | 0 | 3, | 0 | 3.5 | 0 | 3.5 | 3 | 3 | o |
| −25 | | | | | 3.5 | | 3.5 | | | | | | 3.5 | | | | | | | |
| Day | 3.5 | 0 | 3.5 | 0 | 3 | 0 | 3, | 0 | 3 | 0 | 3 | 0 | 3, | 0 | 3.5 | 0 | 3.5 | 0 | 3 | 0 |
| −21 | | | | | | | 3.5 | | | | | | 3.5 | | | | | | | |
| Day | 3 | 2.5 | 3.5 | 0 | 3.5 | 0 | 3 | 2.5, | 3 | 0 | 3, | 0 | 3,5 | 0 | 3.5 | 0 | 3 | 2.5 | 3 | 0 |
| −18 | | | | | | | | 3 | | | 3.5 | | | | | | | | | |
| Day | 3 | 0 | 3, | 0 | 3.5 | 0 | 3.5 | 3 | 3.5 | 0 | 3.5 | 0 | 2.5, | 0 | 3.5 | 0 | 3 | 0 | 2, | 0 |
| −14 | | | 3.5 | | | | | | | | | | 3 | | | | | | 3 | |
| Day | 3 | 0 | 3.5 | 0 | 3.5 | 0 | 3 | 3 | 3 | 3.5 | 3.5 | 0 | 3 | 0 | 3.5 | 0 | 3 | 0 | 3 | 0 |
| −10 | | | | | | | | | | | | | | | | | | | | |
| Day | 3 | 3 | 33 | 0 | 3 | 3 | 3 | 0 | 3.5 | 0 | 3.5 | 0 | 3.5 | 3.5 | 2.5, | 0 | 3 | 3 | 2.5, | 0 |
| −7 | | | | | | | | | | | | | | | 3 | | | | 3 | |
| Day | 3 | 0 | 3.5 | 0 | 3 | 0 | 3.5 | 0 | 3.5 | 0 | 3 | 0 | 2.5 | 0 | 2.5 | 0 | 3 | 0 | 2 | 0 |
| −4 | | | | | | | | | | | | | | | | | | | | |
| Day | 3 | 0 | 2.5, | 0 | 3 | 3 | 3.5 | 0 | 3 | 0 | 3 | 0 | 3.5 | 0 | 3.5 | 3, | 3 | 0 | 2.5, | 0 |
| −1 | | | 3.5 | | | | | | | | | | | | | 3.5 | | | 3 | |

Joy Special Meal Plus NPC-210
Dog ID

| | 13444 | | 1490193 | | 13454 | | 13298 | | 13304 | | 12980 | | 12749 | | 12969 | | 13019 | | 12933 | |
|---|---|---|---|---|---|---|---|---|---|---|---|---|---|---|---|---|---|---|---|---|
| Day | AM | PM | AM | PM | AM | PM | AM | PM | AM | PM | AM | PM | AM | PM | AM | PM | AM | PM | AM | PM |
| Day | 3.5 | 3.5 | 2.5 | 3 | 2,3 | 3 | 2 | 0 | 2, | 3 | 3 | 3 | 2,3 | 3.5 | 3.5 | 3 | 3.5 | 3 | 2.5 | 0 |
| 3 | | | | | | | | | 3 | | | | | | | | | | | |
| Day | 3.5 | 0 | 3 | 2 | 3 | 0 | 3 | 0 | 3.5 | 0 | 3.5 | 0 | 3.5 | 0 | 3, | 0 | 3.5 | 0 | 3.5 | 0 |
| 7 | | | | | | | | | | | | | | | 3.5 | | | | | |
| Day | 3 | 2.5 | 2.5 | 3 | 3.5 | 3 | 3 | 0 | 3.5 | 3.5 | 3 | 3.5 | 3 | 0 | 3.5 | 0 | 3 | 3.5 | 2.5 | 3 |
| 10 | | | | | | | | | | | | | | | | | | | | |
| Day | 2,3 | 1.5 | 2.5 | 2.5 | 2,3 | 0 | 3 | 3.5 | 0 | 0 | 3.5 | 0 | 3.5 | 0 | 3.5 | 0 | 2.5, | 0 | 3.5 | 0 |
| 14 | | | | | | | | | | | | | | | | | 3 | | | |
| Day | 3, | 0 | 3 | 3.5 | 3 | 3, | 3 | 3 | 2.5, | 0 | 3, | 0 | 2,3 | 3 | 3, | 0 | 3.5 | 0 | 3.5 | 0 |
| 17 | 3.5 | | | | | 3.5 | | | 3 | | 3.5 | | | | 3.5 | | | | | |
| Day | 3.5 | 3 | 3, | 2.5 | 3.5 | 0 | 3.5 | 3 | 3.5 | 0 | 3.5 | 3.5 | 3, | 0 | 3.5 | 3.5 | 3.5 | 0 | 3.5 | 3.5 |
| 21 | | | 3.5 | | | | | | | | | | 3.5 | | | | | | | |
| Day | 2.5, | 0 | 3 | 3.5 | 3 | 2.5, | 3.5 | 0 | 3.5 | 0 | 3.5 | 0 | 3.5 | 0 | 3, | 0 | 3 | 3 | 3 | 0 |
| 25 | 3.5 | | | | | 3.5 | | | | | | | | | 3.5 | | | | | |
| Day | 3 | 0 | 3 | 2.5, | 2,3 | 0 | 3.5 | 0 | 3.5 | 0 | 3, | 0 | 2.5, | 0 | 3 | 0 | 3.5 | 0 | 2.5, | 0 |
| 28 | | | | 3 | | | | | | | 3.5 | | 3 | | | | | | 3 | |
| Day | 2.5, | 3 | 2.5, | 2.5 | 3 | 0 | 3, | 0 | 0 | 3 | 3 | 3.5 | 3.5 | 0 | 3, | 0 | 3.5 | 3 | 3, | 0 |
| 32 | 3 | | 3 | | | | 3.5 | | | | | | | | 3.5 | | | | 3.5 | |
| Day | 3.5 | 3.5 | 3 | 3 | 3 | 0 | 3 | 0 | 3 | 0 | 3.5 | 3 | 0 | 0 | 3 | 0 | 3 | 0 | 3 | 0 |
| 35 | | | | | | | | | | | | | | | | | | | | |
| Day | 3 | 0 | 3 | 0 | 3.5 | 0 | 0 | 0 | 3.5 | 0 | 0 | 0 | 3.5 | 0 | 1, | 0 | 2,3 | 0 | 3.5 | 0 |
| 39 | | | | | | | | | | | | | | | 1.5 | | | | | |
| Day | 3 | 2.5 | 2, | 2.5 | 3 | 0 | 3.5 | 3 | 3.5 | 0 | 3 | 0 | 3.5 | 0 | 3.5 | *2 | 2, | 0 | 2.5 | 0 |
| 42 | | | 3.5 | | | | | | | | | | | | | | 2.5 | | | |
| Day | 2, | 1.5 | 3 | 3 | 3, | 0 | 3.5 | 0 | 3.5 | 0 | 2, | 3.5 | 3 | 0 | 3.5 | 0 | 2,3, | 0 | 2.5, | 0 |
| 46 | 3 | | | | 3.5 | | | | | | 3 | | | | | | 3.5 | | 3 | |
| Day | 3.5 | 2 | 3 | 3 | 3.5 | 0 | 3.5 | 3 | 3.5 | 3.5 | 3.5 | 3.5 | 3.5 | 0 | 3 | 0 | 3.5 | 3 | 3.5 | 3.5 |
| 49 | | | | | | | | | | | | | | | | | | | | |
| Day | 1.5, | 0 | 3 | 0 | 3, | 3 | 3.5 | 3 | 3.5 | 3.5 | 3, | 3.5 | 3.5 | 0 | 3.5 | 0 | 3, | 0 | 3, | 0 |
| 53 | 2.5 | | | | 3.5 | | | | | | 3.5 | | | | | | 3.5 | | 3.5 | |
| Day | 2.5, | 0 | 3 | 2 | 3 | 0 | 3 | 2.5 | 2, | 3 | 3 | 0 | 3,3.5 | 0 | 2.5,3 | 0 | 3 | 0 | 2, | 0 |
| 56 | 3 | | | | | | | | 3.5 | | | | | | | | | | 2.5 | |
| Day | 3.5 | 1.5, | 3.5 | 2 | 3.5 | 0 | 3.5 | 3 | 3.5 | 2.5 | 3.5 | 3 | 3.5 | 0 | 3.5 | 0 | 3.5 | 1,2.5 | 3.5, | 0 |
| 60 | | 3 | | | | | | | | | | | | | | | | | 3 | |
| Day | 3, | 3.5 | 3, | 3 | 3.5 | 0 | 3.5 | 0 | 3.5 | 0 | 3.5 | 3.5 | 3.5 | 3.5 | 3.5 | 0 | 3, | 0 | 3, | 3.5 |
| 63 | 3.5 | | 3.5 | | | | | | | | | | | | | | 3.5 | | 3.5 | |
| Day | 3, | 0 | 2.5, | 0 | 3 | 0 | 3 | 0 | 3 | 0 | 3 | 0 | 2.5, | 3.5 | 3 | 0 | 3, | 0 | 3.5 | 3 |
| 67 | 3.5 | | 3 | | | | | | | | | | 3 | | | | 3.5 | | | |
| Day | 3 | 2 | 3 | 3 | 3, | 0 | 2.5, | 3 | 3, | 3 | 2, | 0 | 2, | 0 | 3 | 3 | 1.5, | 2 | 3 | 0 |
| 70 | | | | | 3.5 | | 3 | | 3.5 | | 3 | | 3 | | | | 3 | | | |
| Day | 3 | 0 | 2, | 3 | 3 | 0 | 2.5 | 3 | 2.5 | 2.5 | 2 | 0 | 3 | 0 | 3.5 | 0 | 3 | 0 | 3 | 0 |
| 74 | | | 3 | | | | | | | | | | | | | | | | | |
| Day | 3 | 3 | 3, | 2.5 | 3.5 | 0 | 3.5 | 0 | 3, | 3 | 3 | 3 | 3.5 | 0 | 3.5 | 3.5 | 3.5 | 3 | 3.5 | 0 |
| 77 | | | 3.5 | | | | | | 3.5 | | | | | | | | | | | |
| Day | 3 | 3 | 3, | 3 | 3 | 0 | 3, | 2.5, | 0 | 0 | 3 | 3 | 3.5 | 0 | 3.5 | 0 | 3, | 0 | 3, | 0 |
| 81 | | | 3.5 | | | | 3.5 | 3 | | | | | | | | | 3.5 | | 3.5 | |
| Day | 2.5, | 0 | 1.5, | 0 | 3, | 0 | 3 | 0 | 2, | 0 | 2.5, | 0 | 3.5 | 0 | 2,3 | 0 | 2,2.5 | 0 | 3.5 | 0 |
| 84 | 3 | | 2 | | 3.5 | | | | 3 | | 3 | | | | | | | | | |

Dog ID

| | 13010 | | 12640 | | 12798 | | 13248 | | 13178 | | 13014 | | 12672 | | 13319 | | 13381 | | 13223 | |
|---|---|---|---|---|---|---|---|---|---|---|---|---|---|---|---|---|---|---|---|---|
| Day | AM | PM | AM | PM | AM | PM | AM | PM | AM | PM | AM | PM | AM | PM | AM | PM | AM | PM | AM | PM |
| Day | 3.5 | 0 | 3.5 | 3 | 3 | 0 | 3.5 | 3 | 3.5 | 0 | 2,3 | 0 | 3, | 0 | 2, | 0 | 1.5,3 | 3 | 2,3 | 3.5 |
| 3 | | | | | | | | | | | | | 3.5 | | 3 | | | | | |
| Day | 3 | 0 | 3.5 | 0 | 3.5 | 0 | 3.5 | 0 | 3.5 | 0 | 3.5 | 0 | 3, | 0 | 3.5 | 0 | 3 | 0 | 3.5 | 0 |
| 7 | | | | | | | | | | | | | 3.5 | | | | | | | |
| Day | 3 | 3 | 2.5 | 0 | 3 | 0 | 3.5 | 3.5 | 3.5 | 0 | 3.5 | 3.5 | 3 | 3 | 3.5 | 0 | 2.5 | 3.5 | 3.5 | 3.5 |
| 10 | | | | | | | | | | | | | | | | | | | | |
| Day | 2.5, | 0 | 3.5 | 0 | 2.5 | 0 | 3.5 | 0 | 3.5 | 3.5 | 3 | 0 | 2, | 0 | 1.5, | 0 | 1.5, | 0 | 2,3 | 0 |
| 14 | 3 | | | | | | | | | | | | 3 | | 2 | | 3 | | | |
| Day | 3.5 | 0 | 3 | 3 | 3.5 | 0 | 3 | 0 | 3 | 0 | 3.5 | 3 | 3 | 0 | 3 | 0 | 2.5 | 0 | 3 | 0 |
| 17 | | | | | | | | | | | | | | | | | | | | |
| Day | 3.5 | 0 | 3.5 | 3.5 | 3.5 | 0 | 3.5 | 0 | 3 | 3 | 3.5 | 0 | 3 | 0 | 3, | 0 | 3, | 0 | 3 | 3.5 |
| 21 | | | | | | | | | | | | | | | 3.5 | | 3.5 | | | |
| Day | 3.5 | 0 | 3.5 | 0 | 3.5 | 0 | 3.5 | 3.5 | 3.5 | 0 | 3.5 | 0 | 3 | 3.5 | 3, | 0 | 3 | 0 | 3 | 0 |
| 25 | | | | | | | | | | | | | | | 3.5 | | | | | |
| Day | 3, | 0 | 3.5 | 0 | 3, | 3 | 3 | 0 | 0 | 0 | 3, | 0 | 2.5 | 3 | >3, | 0 | 3, | 0 | 2.5, | 0 |
| 28 | 3.5 | | | | 3.5 | | | | | | 3.5 | | | | 3.5 | | 3.5 | | 3 | |
| Day | 3.5 | 0 | 3 | 3 | 3 | 3 | 3.5 | 0 | 3 | 0 | 1.5, | 0 | 2.5,3 | 3 | 3, | 0 | 3.5 | 0 | 3.5 | 3 |
| 32 | | | | | | | | | | | 3.5 | | | | 3.5 | | | | | |
| Day | 3 | 0 | 3.5 | 3 | 3.5 | 0 | 3.5 | 0 | 3.5 | 0 | 3, | 0 | 3 | 0 | 3 | 0 | 3.5 | 0 | 3 | 0 |
| 35 | | | | | | | | | | | 3.5 | | | | | | | | | |
| Day | 3 | 0 | 0 | 0 | 3.5 | 0 | 3.5 | 0 | 3 | 0 | 3 | 0 | 0 | 3 | >3 | 0 | 3 | 0 | 2.5, | 0 |
| 39 | | | | | | | | | | | | | | | | | | | 3 | |
| Day | 3 | 0 | 3.5 | 0 | 2 | 0 | 3.5 | 0 | 3 | 0 | 2,3 | 3.5 | 2 | 0 | 2.5 | 0 | 3 | 1.5, | 2, | 0 |
| 42 | | | | | | | | | | | | | | | | | | 2 | 2.5 | |
| Day | 3 | 0 | 3.5 | 0 | 3 | 0 | 3,3.5 | 0 | 3 | 3.5 | 2, | 0 | 3 | 0 | 3.5 | 0 | 2.5, | 2 | 2.5, | 0 |
| 46 | | | | | | | | | | | 3.5 | | | | | | 3 | | 3.5 | |
| Day | 3.5 | 3 | 3.5 | 3 | 3.5 | 3.5 | 3.5 | 3 | 3, | 0 | 3.5 | 3.5 | 3, | 3.5 | 3.5 | 0 | 3.5 | 3 | 3 | 3.5 |
| 49 | | | | | | | | | 3.5 | | | | 3.5 | | | | | | | |
| Day | 3 | 3 | 3.5 | 3 | 2.5, | 3.5 | 3.5 | 0 | 3 | 0 | 3 | 0 | 3 | 0 | 2.5, | 0 | 2,3 | 0 | 2, | 0 |
| 53 | | | | | 3 | | | | | | | | | | 3 | | | | 2.5 | |
| Day | 3 | 0 | 3 | 0 | 3 | 0 | 3 | 0 | 2.5 | 3 | 3 | 0 | 3 | 3.5 | 3, | 0 | 3 | 1.5, | 2.5 | 0 |
| 56 | | | | | | | | | | | | | | | 3.5 | | | 2.5 | | |
| Day | 3.5 | 2.5 | 3.5 | 2.5, | 2, | 0 | 3.5 | 0 | 3.5 | 0 | 3.5 | 3 | 3 | 2,3 | 3.5 | 0 | 3.5 | 2,3 | 2,3 | 0 |
| 60 | | | | 3 | 3.5 | | | | | | | | | | | | | | | |
| Day | 3.5 | 3 | 3.5 | 3 | 3.5 | 3.5 | 3.5 | 3.5 | 3.5 | 3.5 | 3.5 | 0 | 3, | 3.5 | 3.5 | 0 | 3, | 0 | 3 | 0 |
| 63 | | | | | | | | | | | | | 3.5 | | | | 3.5 | | | |
| Day | 3, | 0 | 3.5 | 0 | 3.5 | 0 | 3, | 0 | 3.5 | 0 | 3 | 0 | 2.5, | 0 | 3.5 | 0 | 3 | 0 | 2.5, | 0 |
| 67 | 3.5 | | | | | | 3.5 | | | | | | 3 | | | | | | 3 | |
| Day | 3 | 0 | 3.5 | 3 | 3 | 3 | 3.5 | 0 | 2, | 0 | 3 | 3.5 | 2,3 | 3.5 | 3 | 0 | 3,3.5 | 0 | 3 | 3 |
| 70 | | | | | | | | | 2.5 | | | | | | | | | | | |
| Day | 3 | 2.5 | 3 | 2 | 1.5 | 0 | 3.5 | 2.5 | 3 | 0 | 3 | 0 | 3 | 3.5 | 3 | 0 | 2.5 | 0 | 2,3 | 0 |
| 74 | | | | | | | | | | | | | | | | | | | | |
| Day | 3.5 | 3.5 | 3.5 | 3.5 | 3.5 | 0 | 3 | 3 | 3 | 3.5 | 3, | 3 | 3.5 | 3.5 | 2.5, | 0 | 2,3 | 3.5 | 2,3 | 3.5 |
| 77 | | | | | | | | | | | 3.5 | | | | 3 | | | | | |
| Day | 3.5 | 0 | 3.5 | 3.5 | 3 | 0 | 3.5 | 3 | 3 | 0 | 3 | 3.5 | 3.5 | 3.5 | 3, | 0 | 2.5 | 3 | 3.5 | 0 |
| 81 | | | | | | | | | | | | | | | 3.5 | | | | | |
| Day | 3 | 0 | 3, | 0 | 2.5 | 0 | 3 | 0 | 2.5, | 0 | 2, | 0 | 3 | 0 | 2,3 | 0 | 2.5, | 0 | 2,3 | 0 |
| 84 | | | 3.5 | | | | | | 3 | | 2.5 | | | | | | 3 | | | |

Joy Special Meal Only
Dog ID

| | 13114 | | 1490193 | | 13454 | | 13298 | | 13304 | | 12980 | | 12749 | | 12969 | | 13019 | | 12933 | |
|---|---|---|---|---|---|---|---|---|---|---|---|---|---|---|---|---|---|---|---|---|
| Day | AM | PM | AM | PM | AM | PM | AM | PM | AM | PM | AM | PM | AM | PM | AM | PM | AM | PM | AM | PM |
| Day | 3 | 0 | 3.5 | 2.5 | 3.5 | 0 | 3.5 | 0 | 3.5 | 0 | 3.5 | 0 | 3 | 0 | 3.5 | 0 | 2, | 0 | 3.5 | 0 |
| 88 | | | | | | | | | | | | | | | | | 3.5 | | | |
| Day | 3.5 | 0 | 3.5 | 2.5 | 3.5 | 0 | 3.5 | 0 | 3.5 | 0 | 3.5 | 0 | 3 | 0 | 3.5 | 0 | 3.5 | 0 | 3 | 0 |
| 91 | | | | | | | | | | | | | | | | | | | | |
| Day | 3.0 | 0 | 2,3 | 3 | 3.5 | 0 | 3.5 | 3.5 | 3 | 0 | 2.5, | 0 | 0 | 0 | 3.5 | 0 | 2.5, | 0 | 3.5 | 0 |
| 95 | | | | | | | | | | | 3 | | | | | | 3 | | | |
| Day | 2,3 | 1.5 | 2, | 0 | 3.5 | 0 | *3, | 2,2.5 | 2.5, | 0 | 2,3 | 3 | 3.5 | 3 | 3, | 0 | 3.5 | 3 | 3, | 3.5 |
| 98 | | | 3.5 | | | | 3.5 | | 3 | | | | | | 3.5 | | | | 3.5 | |
| Day | 2,3 | 0 | 2, | 3 | 3.5 | 0 | 3 | 3.5 | 3, | 3.5 | 3.5 | 3.5 | 3.5 | 0 | 3 | 0 | 3.5 | 3 | 3.5 | 3.5 |
| 102 | | | 3.5 | | | | | | 3.5 | | | | | | | | | | | |
| Day | 3.5 | 0 | 3 | 3 | 3.5 | 0 | 3.5 | 0 | 3.5 | 0 | 3.5 | 3.5 | 3.5 | 3.5 | 3.5 | 0 | 3, | 0 | 3.5 | 3.5 |
| 105 | | | | | | | | | | | | | | | | | 3.5 | | | |
| Day | 3, | 2,3 | 3.5 | 3 | 3.5 | 0 | 3, | 0 | 3, | 0 | 3.5 | 0 | 3, | 0 | 3.5 | 0 | 3.5 | 0 | 3.5 | 0 |
| 109 | 3.5 | | | | | | 3.5 | | 3.5 | | | | 3.5 | | | | | | | |
| Day | 3.5 | 0 | 2.3 | 0 | 3.5 | 0 | 3.5 | 3.5 | 3, | 0 | 3 | 0 | 3.5 | 0 | 3.5 | 3 | 3.5 | 0 | 3 | 0 |
| 112 | | | | | | | | | 3.5 | | | | | | | | | | | |
| | 13010 | | 12640 | | 12798 | | 13248 | | 13178 | | 13014 | | 12672 | | 13319 | | 13381 | | 13223 | |
| Day | AM | PM | AM | PM | AM | PM | AM | PM | AM | PM | AM | PM | AM | PM | AM | PM | AM | PM | AM | PM |
| Day | 3.5 | 0 | 3.5 | 3.5 | 3.5 | 0 | 3.5 | 3.5 | 3.5 | 0 | 3.5 | 0 | 3.5 | 3.5 | 3.5 | 0 | 3.5 | 3 | 3.5 | 0 |
| 88 | | | | | | | | | | | | | | | | | | | | |
| Day | 3.5 | 0 | 3.5 | 9 | 2.5, | 0 | 3.5 | 0 | 3 5 | 0 | 2.5, | 0 | 3.5 | 0 | 3.5 | 0 | 3.5 | 0 | 2,3 | 0 |
| 91 | | | | | 3.5 | | | | | | 3.5 | | | | | | | | | |
| Day | 3 | 3 | 3.5 | 3.5 | 3, | 0 | 3.5 | 0 | 3.5 | 0 | 3.5 | 0 | 3.5 | 0 | 3, | 0 | 2.5, | 0 | 2,3 | 0 |
| 95 | | | | | 3.5 | | | | | | | | | | 3.5 | | 3.5 | | | |
| Day | 3 | 3 | 3, | 2.5 | 3, | 3 | 3.5 | 2 | 3 | 0 | 3.5 | 3 | 2.5, | 3.5 | 3.5 | 0 | 2.5, | 0 | 1.5, | 3.5 |
| 98 | | | 3.5 | | 3.5 | | | | | | | | 3 | | | | 3 | | 3 | |
| Day | 3, | 0 | 3.5 | 3 | 3.5 | 0 | 3.5 | 0 | 3 | 0 | 3.5 | 0 | 3.5 | 3.5 | 3.5 | 3.5 | 3 | 0 | 3.5 | 0 |
| 102 | 3.5 | | | | | | | | | | | | | | | | | | | |
| Day | 3.5 | 0 | 3.5 | 3.5 | 3.5 | 3.5 | 3.5 | 0 | 35 | 0 | 3 | 0 | 3.5 | 0 | 3.5 | 0 | 3.5 | 3 | 3.5 | 0 |
| 105 | | | | | | | | | | | | | | | | | | | | |
| Day | 3 | 0 | 3.5 | 0 | 3.5 | 3, | 3, | 0 | 2.5, | 3 | 3.5 | 0 | 3, | 0 | 3, | 0 | 3.5 | 3 | 2.5, | 0 |
| 109 | | | | | | 3.5 | 3.5 | | 3 | | | | 3.5 | | 3.5 | | | | 3.5 | |
| Day | 3 | 0 | 3.5 | 0 | 3.5 | 3.5 | 3.5 | 3.5 | 3.5 | 0 | 3.5 | 0 | 3.5 | 0 | 3.5 | 3 | 3.5 | 0 | 3.5 | 0 |
| 112 | | | | | | | | | | | | | | | | | | | | |

*Food vomit
Average Stool Score: 3 (Moist, formed)

Blood Results: Hematology and serum chemistry results are included in Table 4. All mean hematology and serum chemistry values were within normal limits.

TABLE 4
Summary of Hematology and Serum Chemistry Results

| | | | | | | | Alkaline | | Total | Urea | |
|---|---|---|---|---|---|---|---|---|---|---|---|
| | Total | Albu- | | | | | Phos- | | Bili- | Nitro- | |
| | Protein | min | Globulin | AG | AST | ALT | phatase | GGTP | rubin | gen | Creatinine |
| | (g/dL) | (g/dL) | (g/dL) | Ratio | (U/L) | (U/L) | (U/L) | (U/L) | (mg/dL) | (mg/dL) | (mg/dL) |
| | Initial Results | | | | | | | | | | |
| Mean: | 6.5 | 3.5 | 3.0 | 1.2 | 25 | 38 | 39 | 6 | 0.1 | 9 | 0.1 |
| SD: | 0.31 | 0.25 | 0.40 | 0.23 | 5.0 | 13.5 | 14.3 | 1.3 | 0.04 | 1.4 | 0.04 |
| N: | 20 | 20 | 20 | 20 | 20 | 20 | 20 | 20 | 20 | 20 | 20 |
| | Day 1 | | | | | | | | | | |
| Mean: | 6.5 | 3.4 | 3.1 | 1.1 | 27 | 37 | 43 | 5 | 0.1 | 12 | 0.1 |
| SD: | 0.34 | 0.21 | 0.35 | 0.15 | 6.6 | 20.9 | 16.3 | 1.1 | 0.05 | 3.1 | 0.05 |
| N: | 20 | 20 | 20 | 20 | 20 | 20 | 20 | 20 | 2.0 | 20 | 20 |
| | Day 85 | | | | | | | | | | |
| Mean: | 6.6 | 3.5 | 3.1 | 1.1 | 25 | 30 | 41 | 5 | 0.1 | 13 | 0.1 |
| SD: | 0.39 | 0.27 | 0.47 | 0.22 | 6.2 | 16.6 | 15.1 | 1.0 | 0.04 | 2.3 | 0.04 |
| N: | 20 | 20 | 20 | 20 | 20 | 20 | 20 | 20 | 20 | 20 | 20 |
| | Day 113 | | | | | | | | | | |
| Mean: | 6.6 | 3.5 | 3.2 | 1.1 | 24 | 29 | 41 | 6 | 0.1 | 11 | 0.1 |
| SD: | 0.41 | 0.23 | 0.49 | 0.20 | 5.3 | 14.1 | 14.6 | 1.5 | 0.05 | 2.3 | 0.05 |
| N: | 20 | 20 | 20 | 20 | 20 | 20 | 20 | 20 | 20 | 20 | 20 |

| | BUN/ | Phos- | | | Mag- | | Potass- | | Choles- | |
|---|---|---|---|---|---|---|---|---|---|---|
| | Creatinine | phorus | Glucose | Calcium | nesium | Sodium | ium | Chloride | terol | Triglyerides |
| | Ratio | (mg/dL) | (mg/dL) | (mg/dL) | (mEq/L) | (mEq/L) | (mEq/L) | (mEq/L) | (mg/dL) | (mg/dL) |
| | Initial Results | | | | | | | | | |
| Mean: | 14 | 3.6 | 97 | 10.0 | 1.7 | 147 | 4.6 | 113 | 169 | 44 |
| SD: | 1.8 | 0.46 | 7.0 | 0.32 | 0.13 | 1.7 | 0.42 | 1.8 | 27.8 | 12.0 |
| N: | 20 | 20 | 20 | 20 | 20 | 20 | 20 | 20 | 20 | 20 |
| | Day 1 | | | | | | | | | |
| Mean: | 18 | 3.3 | 95 | 10.0 | 1.6 | 147 | 4.4 | 112 | 157 | 53 |
| SD. | 4.0 | 0.63 | 6.3 | 0.36 | 0.12 | 2.5 | 0.21 | 2.1 | 30.8 | 14.5 |
| N: | 20 | 20 | 20 | 20 | 20 | 20 | 20 | 20 | 20 | 20 |
| | Day 85 | | | | | | | | | |
| Mean: | 21 | 3.7 | 94 | 10.1 | 1.6 | 148 | 4.7 | 113 | 190 | 49 |
| SD: | 3.7 | 0.54 | 5.7 | 0.44 | 0.12 | 1.8 | 0.36 | 2.1 | 62.1 | 11.8 |
| N: | 20 | 20 | 20 | 20 | 20 | 20 | 20 | 20 | 20 | 20 |
| | Day 113 | | | | | | | | | |
| Mean: | 17 | 3.3 | 100 | 10.0 | 1.3 | 147 | 4.6 | 113 | 167 | 50 |
| SD: | 3.0 | 0.53 | 5.9 | 0.37 | 0.11 | 1.6 | 0.28 | 1.6 | 33.5 | 8.6 |
| N: | 20 | 20 | 20 | 20 | 20 | 20 | 20 | 20 | 20 | 20 |

| | | WBC | RBC | Hemo- | Hema- | | | | Platelets |
|---|---|---|---|---|---|---|---|---|---|
| | CPK | (10\hat{ }3/ | (10\hat{ }6/ | globin | tocrit | MCV | MCH | MCHC | (10\hat{ }3/ |
| | (U/L) | mm3) | mm3) | (g/dL) | (%) | (um\hat{ }3) | (uug) | (g/dl) | mm3) |
| | Initial Results | | | | | | | | |
| Mean: | 116 | 8.2 | 7.43 | 16.8 | 53.9 | 73 | 22.7 | 31.3 | 288 |
| SD: | 25.1 | 2.19 | 0.651 | 1.30 | 3.67 | 3.8 | 1.02 | 1.43 | 82.8 |
| N: | 20 | 20 | 2.0 | 20 | 20 | 20 | 20 | 20 | 20 |
| | Day 1 | | | | | | | | |
| Mean: | 128 | 8.1 | 7.31 | 16.4 | 54.0 | 74 | 22.5 | 30.4 | 198 |
| SD: | 44.3 | 1.96 | 0.626 | 1.18 | 3.86 | 2.6 | 0.89 | 0.71 | 55.7 |
| N: | 20 | 20 | 20 | 20 | 20 | 20 | 20 | 20 | 20 |
| | Day 85 | | | | | | | | |
| Mean: | 123 | 7.8 | 7.09 | 16.1 | 52.8 | 75 | 22.7 | 30.5 | 312 |
| SD: | 52.6 | 2.23 | 0.613 | 1.37 | 4.40 | 2.6 | 0.56 | 0.79 | 87.5 |
| N: | 20 | 20 | 20 | 20 | 20 | 20 | 20 | 70 | 20 |
| | Day 113 | | | | | | | | |
| Mean: | 113 | 7.4 | 7.18 | 16.4 | 52.6 | 73 | 22.9 | 31.2 | 295 |
| SD: | 36.0 | 1.55 | 0.543 | 1.26 | 3.68 | 2.1 | 0.98 | 0.80 | 82.5 |
| N: | 20 | 20 | 20 | 20 | 20 | 20 | 20 | 20 | 20 |

| | Abs | % | Abs | % | Abs | % | Abs | % | Abs | % | Abs | % |
|---|---|---|---|---|---|---|---|---|---|---|---|---|
| | Polys | Polys | Bands | Bands | Lymphs | Lymphs | Monos | Monos | Eos | Eos | Basos | Basos |
| | Initial Results | | | | | | | | | | | |
| Mean: | 5607 | 68 | 0 | 0 | 1928 | 24 | 347 | 4 | 270 | 3 | 3 | 0 |
| SD: | 1675.3 | 5.9 | 0.0 | 0.0 | 623.2 | 6.3 | 134.0 | 1.0 | 130.7 | 1.3 | 13.6 | 0.2 |
| N: | 20 | 20 | 20 | 20 | 20 | 20 | 20 | 20 | 20 | 20 | 20 | 20 |
| | Day 1 | | | | | | | | | | | |
| Mean: | 5340 | 66 | 0 | 0 | 2076 | 26 | 309 | 5 | 270 | 3 | 0 | 0 |
| SD: | 1469.1 | 6.7 | 0.0 | 0.0 | 740.3 | 6.3 | 101.8 | 1.5 | 155.9 | 1.8 | 0.0 | 0.0 |
| N: | 20 | 20 | 20 | 20 | 20 | 20 | 20 | 20 | 20 | 20 | 20 | 20 |
| | Day 85 | | | | | | | | | | | |
| Mean: | 5173 | 66 | 0 | 0 | 1991 | 26 | 333 | 4 | 288 | 4 | 0 | 0 |
| SD: | 1534.4 | 5.1 | 0.0 | 0.0 | 660.5 | 5.0 | 161.4 | 1.3 | 158.8 | 1.6 | 0.0 | 0.0 |
| N: | 20 | 20 | 20 | 20 | 20 | 20 | 20 | 20 | 20 | 20 | 20 | 20 |
| | Day 113 | | | | | | | | | | | |
| Mean: | 5044 | 68 | 0 | 0 | 1852 | 25 | 295 | 4 | 239 | 3 | 0 | 0 |
| SD: | 1226.9 | 6.6 | 0.0 | 0.0 | 576.0 | 6.6 | 116.4 | 1.1 | 111.5 | 1.3 | 0.0 | 0.0 |
| N: | 20 | 20 | 20 | 20 | 20 | 20 | 20 | 20 | 20 | 20 | 20 | 20 |

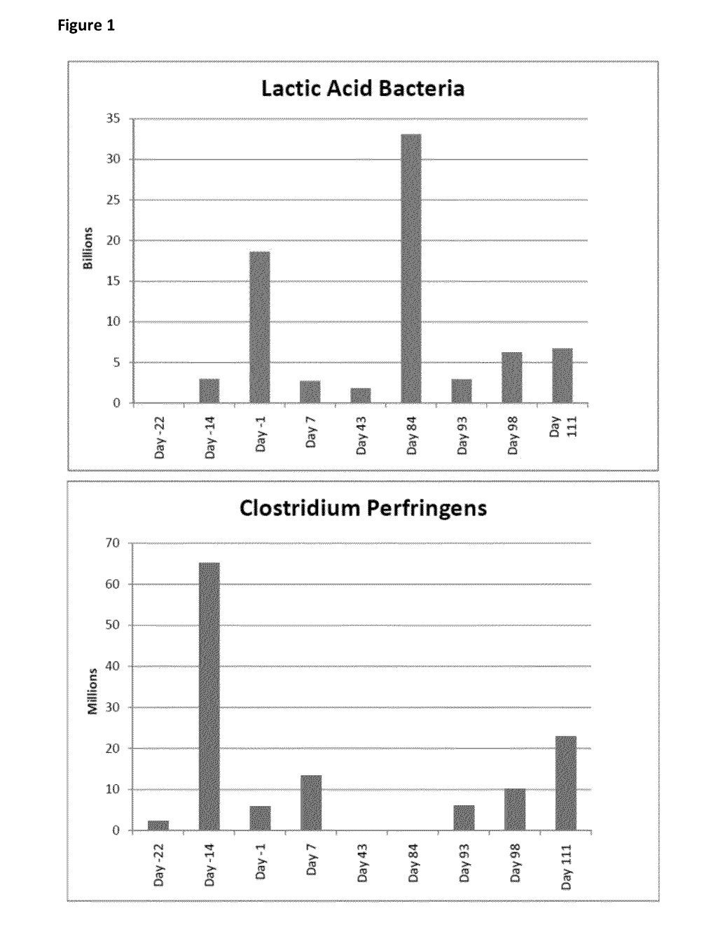

Fecal Cultures: After the dogs had consumed the test product NPC-210 for 84 days, the mean lactic acid bacteria fecal count had peaked while the mean Clostridium perfringens fecal count was at its lowest level during the study. Once administration of the product was discontinued the lactic acid bacteria fecal counts began to decrease with a concurrent increase in Clostridium perfringens fecal counts. See Tables 5-13 and FIG. 1.

TABLE 5
Day −22 Fecal Cultures

| | Lactic Acid Bacteria | Clostridium Perfringens |
|---|---|---|
| Dog # | (cfu/g) | (cfu/g) |
| 13444 | >2000000 | <10 |
| 1490193 | >2000000 | <10 |
| 13454 | >2000000 | <10 |
| 13298 | >2000000 | <10 |
| 13304 | >2000000 | <10 |
| 12980 | >2000000 | <10 |
| 12749 | >2000000 | 56,000 |
| 12969 | >2000000 | >5700000 |
| 13019 | >2000000 | >5700000 |
| 12933 | >2000000 | >5700000 |
| 13010 | >2000000 | >5700000 |
| 12640 | >2000000 | >5700000 |
| 12798 | >2000000 | >5700000 |
| 13248 | >2000000 | >5700000 |
| 13178 | >2000000 | <10 |
| 13014 | >2000000 | <10 |
| 12672 | >2000000 | <10 |
| 13319 | >2000000 | <10 |
| 13381 | >2000000 | 5,700,000 |
| 13223 | >2000000 | <10 |

TABLE 6
Day −14 Fecal Cultures

| | Lactic Acid Bacteria | Clostridium Perfringens |
|---|---|---|
| Dog # | (cfu/g) | (cfu/g) |
| 13444 | 5,300,000,000 | <10 |
| 1490193 | 7,600,000,000 | <10 |
| 13454 | 14,600,000 | <10 |
| 13298 | 5,200,000,000 | <10 |
| 13304 | 5,700,000 | <10 |
| 12980 | 1,220,000,000 | <10 |
| 12749 | 3,200,000,000 | <10 |
| 12969 | 530,000,000 | <10 |
| 13019 | 430,000,000 | <10 |
| 12933 | 300,000,000 | <10 |
| 13010 | 5,300,000,000 | <10 |
| 12640 | 1,400,000,000 | <10 |
| 12798 | 5,100,000,000 | 686,400,000 |
| 13248 | 4,000,000,000 | 61,600,000 |
| 13178 | 350,000,000 | <10 |
| 13014 | 430,000,000 | <10 |
| 12672 | 350,000,000 | <10 |
| 13319 | 2,200,000,000 | <10 |
| 13381 | 3,300,000,000 | <10 |
| 13223 | 13,000,000,000 | <10 |

TABLE 7
Day −1 Fecal Cultures

| | Lactic Acid Bacteria | Clostridium Perfringens |
|---|---|---|
| Dog # | (cfu/g) | (cfu/g) |
| 13444 | 2,000,000,000 | <1000000 |
| 1490193 | 7,700,000,000 | 100,000,000 |
| 13454 | 60,000,000 | <1000000 |
| 13298 | 640,000,000 | <1000000 |
| 13304 | 25,000,000,000 | <1000000 |
| 12980 | 1,500,000,000 | <1000000 |
| 12749 | 150,000,000 | <1000000 |
| 12969 | 5,900,000,000 | <1000000 |
| 13019 | 4,100,000,000 | <1000000 |
| 12933 | 140,000,000,000 | <1000000 |
| 13010 | 15,000,000,000 | <1000000 |
| 12640 | 83,000,000,000 | <1000000 |
| 12798 | 25,000,000,000 | <1000000 |
| 13248 | 30,000,000,000 | <1000000 |
| 13178 | 330,000,000 | <1000000 |
| 13014 | 19,000,000,000 | <1000000 |
| 12672 | 120,000,000 | <1000000 |
| 13319 | 200,000,000 | <1000000 |
| 13381 | 7,300,000,000 | <1000000 |
| 13223 | 5,800,000,000 | <1000000 |

TABLE 8
Day 7 Fecal Cultures

| | Lactic Acid Bacteria | Clostridium Perfringens |
|---|---|---|
| Dog # | (cfu/g) | (cfu/g) |
| 13444 | 3,000,000,000 | <1000000 |
| 1490193 | 1,400,000,000 | <1000000 |
| 13454 | 2,800,000,000 | <1000000 |
| 13298 | 1,600,000,000 | <1000000 |
| 13304 | 11,000,000,000 | <1000000 |
| 12980 | 1,300,000,000 | <1000000 |
| 12749 | 3,100,000,000 | <1000000 |
| 12969 | 3,300,000,000 | 82,000,000 |
| 13019 | 2,200,000,000 | <1000000 |
| 12933 | 3,000,000,000 | <1000000 |
| 13010 | 5,100,000,000 | <57000000 |
| 12640 | 3,000,000,000 | <1000000 |
| 12798 | 3,300,000,000 | <1000000 |
| 13248 | 460,000,000 | <57000000 |
| 13178 | 880,000,000 | <100000 |
| 13014 | 3,900,000,000 | <1000000 |
| 12672 | 780,000,000 | <1000000 |
| 13319 | 2,700,000,000 | <57000000 |
| 13381 | 1,200,000,000 | <1000000 |
| 13223 | 550,000,000 | <1000000 |

TABLE 9
Day 43 Fecal Cultures

| | Lactic Acid Bacteria | Clostridium Perfringens |
|---|---|---|
| Dog # | (cfu/g) | (cfu/g) |
| 13444 | 8,500,000,000 | 100,000 |
| 1490193 | 2,600,000,000 | 54,000 |
| 13454 | 640,000,000 | <100000 |
| 13298 | 970,000,000 | <100000 |
| 13304 | 3,800,000,000 | <100000 |
| 12980 | 780,000,000 | <100000 |
| 12749 | 6,200,000,000 | <100000 |
| 12969 | 3,000,000,000 | <100000 |
| 13019 | 900,000,000 | <100000 |
| 12933 | 320,000,000 | <100000 |
| 13010 | 560,000,000 | <100000 |
| 12640 | 790,000,000 | <100000 |
| 12798 | 540,000,000 | <100000 |
| 13248 | 200,000,000 | <100000 |
| 13178 | 160,000,000 | <100000 |
| 13014 | 400,000,000 | <100000 |
| 12672 | 100,000,000 | <100000 |
| 13319 | 120,000,000 | <100000 |
| 13381 | 5,500,000,000 | 98,000 |
| 13223 | 880,000,000 | <100000 |

TABLE 10
Day 84 Fecal Cultures

| | Lactic Acid Bacteria | Clostridium Perfringens |
|---|---|---|
| Dog # | (cfu/g) | (cfu/g) |
| 13444 | 8,600,000,000 | <1000 |
| 1490193 | 10,600,000,000 | 970,000 |
| 13454 | 6,700,000,000 | <1000 |
| 13298 | 860,000,000 | <1000 |
| 13304 | 2,100,000,000 | <1000 |
| 12980 | 5,200,000,000 | <1000 |
| 12749 | 250,000,000 | <1000 |
| 12969 | 6,200,000,000 | <1000 |
| 13019 | 5,300,000,000 | 100,000 |
| 12933 | 2,500,000,000 | <1000 |
| 13010 | 8,500,000,000 | 15,000 |
| 12640 | 540,000,000,000 | <1000 |
| 12798 | 660,000,000 | <1000 |
| 13248 | 55,000,000,000 | <1000 |
| 13178 | 2,800,000,000 | <1000 |
| 13014 | 750,000,000 | <1000 |
| 12672 | 760,000,000 | <1000 |
| 13319 | 2,300,000,000 | 100,000 |
| 13381 | 1,300,000,000 | <1000 |
| 13223 | 1,800,000,000 | <1000 |

TABLE 11
Day 93 Fecal Cultures

| | Lactic Acid Bacteria | Clostridium Perfringens |
|---|---|---|
| Dog # | (cfu/g) | (cfu/g) |
| 13444 | 2,800,000,000 | 1,900,000 |
| 1490193 | 2,700,000,000 | 41,000,000 |
| 13454 | 40,000,000 | <1000 |
| 13298 | 1,900,000,000 | <1000 |
| 13304 | 1,900,000,000 | <1000 |
| 12980 | 5,000,000,000 | <1000 |
| 12749 | 3,700,000,000 | 1,000 |
| 12969 | 3,300,000,000 | 30,000 |
| 13019 | 2,300,000,000 | 42,000,000 |
| 12933 | 6,500,000,000 | <1000 |
| 13010 | 4,600,000,000 | <1000 |
| 12640 | 4,100,000,000 | <1000 |
| 12798 | 8,400,000,000 | 37,000,000 |
| 13248 | 540,000,000 | <1000 |
| 13178 | 5,200,000,000 | <1000 |
| 13014 | 300,000,000 | <1000 |
| 12672 | 40,000,000 | <1000 |
| 13319 | 5,100,000,000 | <1000 |
| 13381 | 50,000,000 | <1000 |
| 13223 | 310,000,000 | <1000 |

TABLE 12
Day 98 Fecal Cultures

| | Lactic Acid Bacteria | Clostridium Perfringens |
|---|---|---|
| Dog # | (cfu/g) | (cfu/g) |
| 13444 | 14,000,000,000 | 4,000,000 |
| 1490193 | 4,800,000,000 | <100 |
| 13454 | 600,000,000 | <100 |
| 13298 | 5,000,000,000 | 100,000,000 |
| 13304 | 4,100,000,000 | <100 |
| 12980 | 32,000,000,000 | <100 |
| 12749 | 3,800,000,000 | 46,000,000 |
| 12969 | 220,000,000 | <100 |
| 13019 | 410,000,000 | <100 |
| 12933 | 630,000,000 | <100 |
| 13010 | 20,000,000,000 | 3,100,000 |
| 12640 | 7,200,000,000 | <100 |
| 12798 | 5,400,000,000 | <100 |
| 13248 | 11,000,000,000 | <100 |
| 13178 | 4,400,000,000 | <100 |
| 13014 | 290,000,000 | <100 |
| 12672 | 4,400,000,000 | <100 |
| 13319 | 460,000,000 | 23,000,000 |
| 13381 | 620,000,000 | 28,000,000 |
| 13223 | 5,800,000,000 | <100 |

TABLE 13
Day 111 Fecal Cultures

| | Lactic Acid Bacteria | Clostridium Perfringens |
|---|---|---|
| Dog # | (cfu/g) | (cfu/g) |
| 13444 | 1,900,000,000 | <1000 |
| 1490193 | 47,000,000,000 | 460,000,000 |
| 13454 | 400,000,000 | <1000 |
| 13298 | 1,100,000,000 | <1000 |
| 13304 | 1,300,000,000 | <1000 |
| 12980 | 26,000,000,000 | <1000 |
| 12749 | 6,900,000,000 | <1000 |
| 12969 | 16,000,000,000 | <1000 |
| 13019 | 2,900,000,000 | <1000 |
| 12933 | 180,000,000 | <1000 |
| 13010 | 1,400,000,000 | <1000 |
| 12640 | 6,800,000,000 | <1000 |
| 12798 | 3,500,000,000 | <1000 |
| 13248 | 8,600,000,000 | <1000 |
| 13178 | 1,800,000,000 | <1000 |
| 13014 | 630,000,000 | <1000 |
| 12672 | 870,000,000 | <1000 |
| 13319 | 4,900,000,000 | <1000 |
| 13381 | 1,800,000,000 | <1000 |
| 13223 | 900,000,000 | <1000 |

Physical Examination/Clinical Signs: A physical examination was conducted by the staff veterinarian prior to the initiation of the study, and all dogs were considered to be in good health. Physical examinations were also conducted at study completion. Dog ID #12980 exhibited a mild head tilt to the right and Dog IDs #12749 and #13014 both exhibited heart murmurs during the final physical examinations. During the study, a low incidence of loose stools or food vomit was observed for a minority of dogs. Occasional episodes of loose stools or food emesis are not uncommon for Beagle dogs, and these findings were not considered to be correlated with the consumption of the test product. The gender and age of the dogs used in this study are shown in Table 14.

TABLE 14
Animal gender and age information

| Dog ID | Sex | Date of Birth |
|---|---|---|
| 13444 | M | Feb. 20, 2012 |
| 1490193 | M | Mar. 10, 2010 |
| 13454 | F | Feb. 25, 2012 |
| 13298 | M | Mar. 18, 2011 |
| 13304 | M | Mar. 25, 2011 |
| 12980 | M | Jan. 31, 2008 |
| 12749 | F | Aug. 31, 2006 |
| 12969 | F | Jan. 10, 2008 |
| 13019 | M | Jul. 22, 2008 |
| 12933 | F | Oct. 24, 2007 |
| 13010 | M | Jul. 7, 2008 |
| 12640 | F | May 9, 2006 |
| 12798 | M | Nov. 5, 2006 |
| 13248 | F | Oct. 17, 2010 |
| 13178 | F | May 6, 2010 |
| 13014 | F | Jul. 22, 2008 |
| 12672 | F | Jun. 18, 2006 |
| 13319 | F | May. 17, 2011 |
| 13381 | F | Oct. 10, 2011 |
| 13223 | F | Sep. 2, 2010 |

In summary, all 20 dogs completed the study. After 84 days of receiving NPC-210 at a dosage of about 1×10⁹ CFU per dog per day, treated dogs exhibited an increase in lactic acid bacteria and a concurrent decrease in Clostridium perfringens. A test article related effect was not evident on food consumption, hematology and clinical chemistry values. Body weights exhibited a positive change while the dogs were consuming NPC-210 and a negative change when on the standard diet alone without NPC-210 supplement. During the trial period, the concentration of Clostridium perfringens decreased by 2.9 logs which is a 99.6% reduction in bacteria. Considering all data analyzed, Lactobacilli supplements have a significant effect on weight gain and on pathogen reduction in dogs.

We claim:

1. A composition comprising a lactic acid producing bacterium and a pet food ingredient, said lactic acid producing bacterium being present in said composition at a concentration ranging from about 1×10² CFU to about 1×10¹² CFU per gram of said composition.

2. The composition of claim 1, wherein said lactic acid producing bacterium comprises at least one Lactobacillus strain selected from the group consisting of LA51, M35, LA45, NP28, L411 strains and combination thereof.

3. The composition of claim 1, said lactic acid producing bacterium being a Lactobacillus animalis strain, wherein said Lactobacillus animalis strain is not native to canines.

4. The composition of claim 1, wherein said lactic acid producing bacterium comprises strain LA51.

5. The composition of claim 1, wherein said composition does not contain significant amount of lactic acid utilizing bacterium.

6. The composition of claim 1, wherein said composition does not contain significant amount of Propionibacterium freudenreichii.

7. The composition of claim 1, wherein the pet food ingredient and the lactic acid producing bacterium form a pre-mix having certain geometric shape.

8. The composition of claim 7, wherein the pre-mix has a shape selected from the group consisting of a pet chew, a kibble, a bone, and a pet toy.

9. The composition of claim 8, wherein the lactic acid producing bacterium forms a coating on the outside of the pre-mix.

10. The composition of claim 1, wherein the pet food ingredient comprises maltodextrin.

11. The composition of claim 1, wherein the pet food ingredient comprises a flavoring, wherein said flavoring enhances the likability of said composition to a pet selected from the group consisting of a dog, a cat, and a rodent.

12. A composition to be used as a dietary supplement for a pet, said composition comprising a lactic acid producing bacterium, said lactic acid producing bacterium being supplemented to said pet at a dosage of from about 1×10⁶ to about 1×10¹² CFU per pet per day.

13. The composition of claim 12, wherein said lactic acid producing bacterium is supplemented to said pet at a dosage of from about 1×10⁹ to about 5×10⁹ CFU per pet per day.

14. A method for improving feed utilization or reducing pathogen in a pet, said method comprising:
(a) administering to said pet a composition comprising a lactic acid producing bacterium at a dosage ranging from about 1×10³ to about 1×10¹⁰ CFU of lactic acid producing bacterium per pet per day, wherein said lactic acid producing bacterium is pre-mixed with food or water for the pet to form a mixture before said mixture is administered to the pet.

15. The method of claim 14, further comprising a step (b) of measuring the weight gain or pathogen content of said pet to determine the effects of the administration step (a).

16. The method of claim 14, wherein said administration step (a) is conducted daily for at least 2 weeks.

17. The method of claim 14, wherein said lactic acid producing bacterium comprises at least one Lactobacillus strain selected from the group consisting of LA51, M35, LA45, NP28, L411 strains and combination thereof.

18. The method of claim 14, wherein said lactic acid producing bacterium is a Lactobacillus animalis strain that is not native to canines

19. The method of claim 14, wherein said lactic acid producing bacterium is supplemented to said pet at a dosage of from about 1×10⁹ to about 5×10⁹ CFU per pet per day.

20. The method of claim 19, wherein said lactic acid producing bacterium at said dosage improves feed efficiency of said pet by at least 2%.

21. The method of claim 19, wherein said lactic acid producing bacterium at said dosage reduces pathogen count in said pet by at least 20% when compared with pathogen count in an untreated pet, wherein said pathogen is selected from the group consisting of Clostridium perfringens, Salmonella typhimurium, E. coli, Staphylococcus aureus, Bordetella bronchiseptica, Campylobacter jejuni and combination thereof.

22. The method of claim 14, wherein said lactic acid producing bacterium is packaged in a separate container, and wherein said lactic acid producing bacterium is mixed with food or water for the pet to form a mixture on site before said mixture is administered to the pet.
